(19) United States
(12) Patent Application Publication
(10) Pub. No.: US 2024/0430981 A1
(43) Pub. Date: Dec. 26, 2024

(54) MANAGING CONFIGURATIONS FOR MULTICAST AND UNICAST COMMUNICATIONS

(71) Applicant: GOOGLE LLC, Mountain View, CA (US)

(72) Inventor: Chih-Hsiang Wu, Taoyuan City (TW)

(21) Appl. No.: 18/703,055

(22) PCT Filed: Oct. 21, 2022
(86) PCT No.: PCT/US22/47355

§ 371 Date: Apr. 19, 2024

Related U.S. Application Data
(60) Provisional application No. 63/270,324, filed on Oct. 21, 2021.

(51) Int. Cl. H04W 76/40; H04W 72/1263

(52) U.S. Cl. CPC H04W 76/40; H04W 72/1263

(57) ABSTRACT

In a method for configuring a radio bearer, a distributed unit (DU) of a distributed base station receives, from a central unit (CU) of the distributed base station, a request to configure radio resources for a radio bearer and, based on one or more factors associated with the radio bearer, either includes or refrains from including in a response one or more configuration parameters for the radio bearer. The DU also transmits the response to the CU.

### FIELD OF THE DISCLOSURE

This disclosure relates to wireless communications and, more particularly, to enabling setup and/or modification of radio resources for unicast, multicast, and/or broadcast communications.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP sublayer defined for the Evolved Universal Terrestrial Radio Access (EUTRA) radio interface (see Third Generation Partnership Project (3GPP) specification TS 36.323) and New Radio (NR) (see 3GPP specification TS 38.323) provides sequencing of protocol data units (PDUs) in the uplink direction from a user device (also known as a user equipment or “UE”) to a base station, as well as in the downlink direction from the base station to the UE. The PDCP sublayer also provides services for signaling radio bearers (SRBs) to the Radio Resource Control (RRC) sublayer. The PDCP sublayer further provides services for data radio bearers (DRBs) to a Service Data Adaptation Protocol (SDAP) sublayer or a protocol layer such as an Internet Protocol (IP) layer, an Ethernet protocol layer, or an Internet Control Message Protocol (ICMP) layer. Generally, the UE and a base station can use SRBs to exchange RRC messages as well as non-access stratum (NAS) messages, and can use DRBs to transport data on a user plane.

The UE in some scenarios can concurrently utilize resources of multiple nodes (e.g., base stations or components of a distributed base station or disaggregated base station) of a radio access network (RAN), interconnected by a backhaul. When these network nodes support different radio access technologies (RATs), this type of connectivity is referred to as multi-radio dual connectivity (MR-DC). When operating in MR-DC, the cell(s) associated with the base station operating as a master node (MN) define a master cell group (MCG), and the cells associated with the base station operating as a secondary node (SN) define the secondary cell group (SCG). The MCG covers a primary cell (PCell) and zero, one, or more secondary cells (SCells), and the SCG covers a primary secondary cell (PSCell) and zero, one, or more SCells. The UE communicates with the MN (via the MCG) and the SN (via the SCG). In other scenarios, the UE utilizes resources of one base station at a time, in single connectivity (SC). The UE in SC only communicates with the MN, via the MCG. A base station and/or the UE determines when the UE should establish a radio connection with another base station. For example, a base station can determine to hand the UE over to another base station, and initiate a handover procedure. The UE in other scenarios can concurrently utilize resources of another RAN node (e.g., a base station or a component of a distributed or disaggregated base station), interconnected by a backhaul.

UEs can use several types of SRBs and DRBs. So-called “SRB1” resources carry RRC messages, which in some cases include NAS messages over the dedicated control channel (DCCH), and “SRB2” resources support RRC messages that include logged measurement information or NAS messages, also over the DCCH but with lower priority than SRB1 resources. More generally, SRB1 and SRB2 resources allow the UE and the MN to exchange RRC messages related to the MN and embed RRC messages related to the SN, and can also be referred to as MCG SRBs. “SRB3” resources allow the UE and the SN to exchange RRC messages related to the SN, and can also be referred to as SCG SRBs. Split SRBs allow the UE to exchange RRC messages directly with the MN via lower-layer resources of the MN and the SN. Further, DRBs terminated at the MN and using the lower-layer resources of only the MN can be referred as MCG DRBs, DRBs terminated at the SN and using the lower-layer resources of only the SN can be referred as SCG DRBs, and DRBs terminated at the MN or SN but using the lower-layer resources of both the MN and the SN can be referred to as split DRBs. DRBs terminated at the MN but using the lower-layer resources of only the SN can be referred to as MN-terminated SCG DRBs. DRBs terminated at the SN but using the lower-layer resources of only the MN can be referred to as SN-terminated MCG DRBs.

UEs can perform handover procedures to switch from one cell to another, whether in SC or DC operation. These procedures involve messaging (e.g., RRC signaling and preparation) among RAN nodes and the UE. The UE may handover from a cell of a serving base station to a target cell of a target base station, or from a cell of a first distributed unit (DU) of a serving base station to a target cell of a second DU of the same base station, depending on the scenario. In DC scenarios, UEs can perform PSCell change procedures to change PSCells. These procedures involve messaging (e.g., RRC signaling and preparation) among RAN nodes and the UE. The UE may perform a PSCell change from a PSCell of a serving SN to a target PSCell of a target SN, or from a PSCell of a source DU of a base station to a PSCell of a target DU of the same base station, depending on the scenario. Further, the UE may perform handover or PSCell change within a cell for synchronous reconfiguration.

Base stations that operate according to fifth-generation (5G) New Radio (NR) requirements support significantly larger bandwidth than fourth-generation (4G) base stations. Accordingly, the Third Generation Partnership Project (3GPP) has proposed that for Release 15, UEs support a 100 MHz bandwidth in frequency range 1 (FR1) and a 400 MHZ bandwidth in frequency range (FR2). Due to the relatively wide bandwidth of a typical carrier in 5G NR. 3GPP has proposed for Release 17 that a 5G NR base station be able to provide multicast and/or broadcast service(s) (MBS) to UEs. MBS can be useful in many content delivery applications, such as transparent IPv4/IPv6 multicast delivery, IPTV, software delivery over wireless, group communications, Internet of Things (IoT) applications, V2X applications, and emergency messages related to public safety, for example.

5G NR provides both point-to-point (PTP) and point-to-multipoint (PTM) delivery methods for the transmission of MBS packet flows over the radio interface. In PTP communications, a RAN node transmits different copies of each MBS data packet to different UEs over the radio interface, while in PTM communications a RAN node transmits a single copy of each MBS data packet to multiple UEs over the radio interface. In some scenarios, however, it is unclear what configurations a base station should generate for UEs to receive an MBS data packet multicast and/or unicast by the base station.

### SUMMARY

In one aspect of this disclosure, a method for configuring a radio bearer is performed by a DU of a distributed base station. The method includes receiving, from a central unit (CU) of the distributed base station, a request to configure radio resources for a radio bearer. The method also includes, based on one or more factors associated with the radio bearer, either including or refraining from including in a response one or more configuration parameters for the radio bearer. The method further includes transmitting the response to the CU.

In another aspect of this disclosure, a method for configuring a radio bearer is performed by a RAN node. The method includes determining to configure radio resources for a radio bearer and, based on whether the radio bearer is or is not an MRB, including or refraining from including, respectively, a first RLC parameter in a configuration for the radio bearer. The method also includes transmitting the configuration to another node.

In another aspect of this disclosure, a method for configuring an MRB associated with an MBS session is performed by a CU of a distributed base station that also includes a DU. The method includes determining whether the MRB or the MBS session requires uplink resources and, based on the determining, including or refraining from including in a CU-to-DU message an indication that the MRB or the MBS session requires uplink resources. The method also includes transmitting the CU-to-DU message to the DU.

In another aspect of this disclosure, a method for configuring a radio bearer is performed by a CU of a distributed base station that also includes a DU. The method includes determining an RLC mode for the radio bearer, including an indication of the RLC mode in a CU-to-DU message, and transmitting the CU-to-DU message to the DU.

### BRIEF DESCRIPTION OF THE DRAWINGS

FIG. 1A is a block diagram of an example system in which the techniques of this disclosure for managing transmission and reception of MBS information can be implemented;

FIG. 1B is a block diagram of an example base station in which a centralized unit (CU) and a distributed unit (DU) can operate in the system of FIG. 1A;

FIG. 2A is a block diagram of an example protocol stack according to which the UE of FIG. 1A can communicate with base stations of FIG. 1A;

FIG. 2B is a block diagram of an example protocol stack according to which the UE of FIG. 1A can communicate with a DU and a CU of a base station;

FIG. 3 is a block diagram illustrating example tunnel architectures for MBS sessions and PDU sessions;

FIG. 4 is a block diagram illustrating example MRBs and DRBs which a distributed base station can configure for communicating multicast, broadcast, and/or unicast traffic with UEs;

FIGS. 5A-5B are messaging diagrams of an example scenario in which a CN and a distributed base station configure resources for transmitting MBS data of an MBS session to multiple UEs; and

FIGS. 6A-14 are flow diagrams of example methods for configuring configuration parameters for a DRB and a MRB, which can be implemented in a base station of FIG. 1A or in a CU or a DU of FIG. 1B.

### DETAILED DESCRIPTION OF THE DRAWINGS

Generally, a radio access network (RAN) and/or a core network (CN) implement the techniques of this disclosure to manage transmission of multicast and/or broadcast services (MBS). A CN can request that a base station configure a common downlink (DL) tunnel via which the CN can transmit MBS data for an MBS session to the base station, for multiple user equipment (UEs). In response to the request, the base station transmits a configuration of the common DL tunnel to the CN. The configuration can include transport-layer information such as an Internet Protocol (IP) address and a tunnel identifier (e.g., a Tunnel Endpoint Identifier (TEID)).

The base station can also configure one or more logical channels toward the UEs, and/or one or more MBS radio bearers (MRBs) associated with the MBS session, where there may be a one-to-one mapping between each logical channel and each MRB. After receiving MBS data for the MBS session via the common DL tunnel, the base station can transmit the MBS data via the one or more logical channels to one or more UEs that have joined the MBS session. In some implementations, the base station transmits MBS data to multiple UEs via a single logical channel. Further, if there are multiple quality-of-service (QoS) flows for the MBS session, a single logical channel may be associated with the multiple QoS flows, or there may be a one-to-one mapping between each QoS flow and each logical channel.

The CN can cause the base station to configure the common DL tunnel before or after a UE joins the MBS session. If additional UEs join the MBS session after the tunnel is configured, the CN can utilize the same common DL tunnel to transmit MBS data, for the multiple UEs, to the base station.

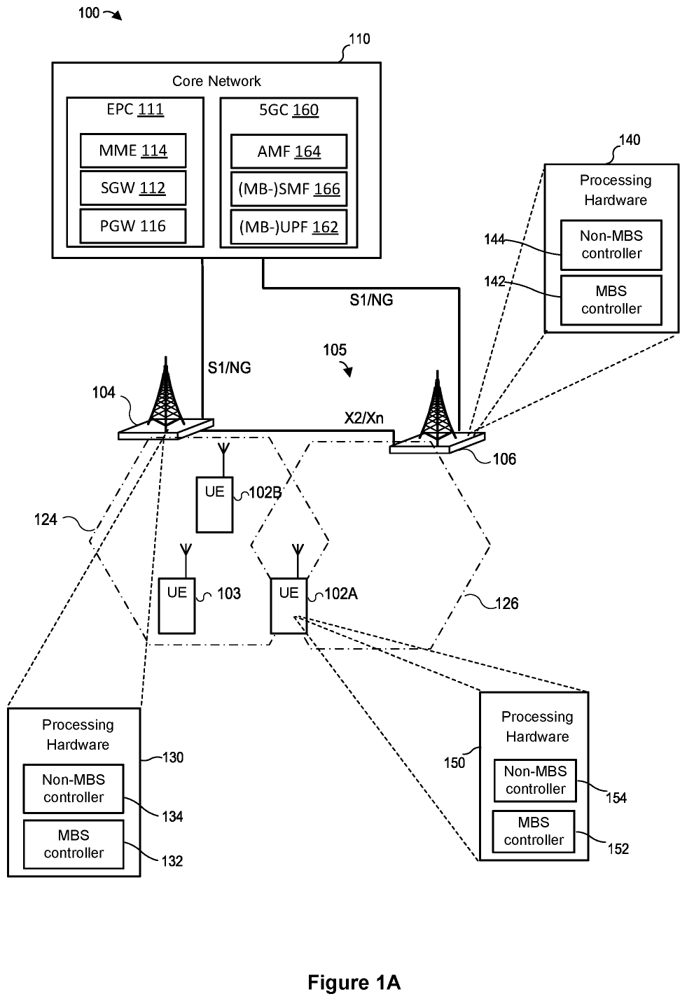

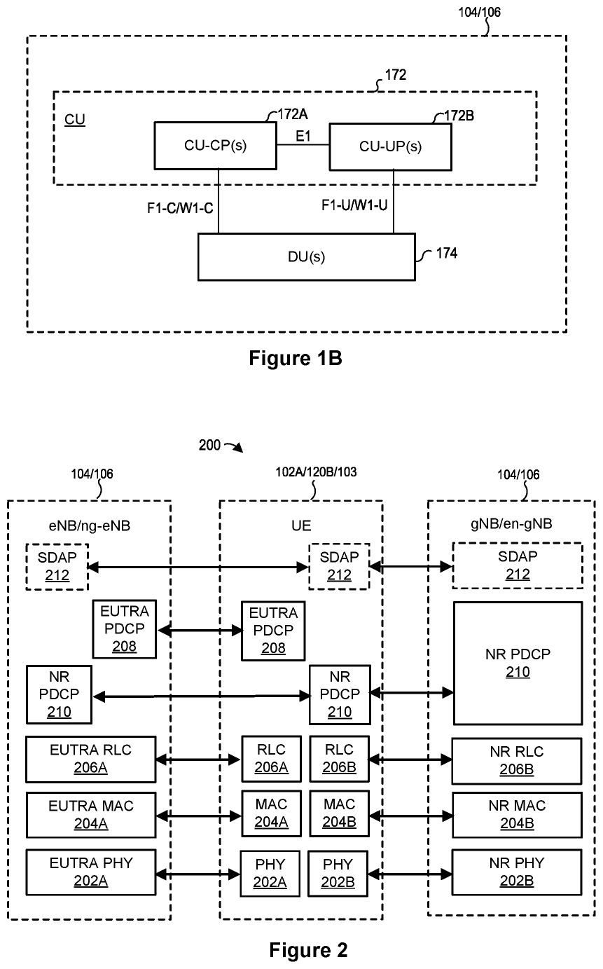

FIG. 1A depicts an example wireless communication system 100 in which techniques of this disclosure for managing transmission and reception of MBS information can be implemented. The wireless communication system 100 includes UEs 102A, 102B, 103, as well as base stations 104, 106 of a RAN 105 connected to a CN 110. In other implementations or scenarios, the wireless communication system 100 may instead include more or fewer UEs, and/or more or fewer base stations, than are shown in FIG. 1A. The base stations 104, 106 can be of any suitable type, or types, of base stations, such as an evolved node B (eNB), a next-generation eNB (ng-NB), or a 5G Node B (gNB), for example. As a more specific example, the base station 104 may be an eNB or a gNB, and the base stations 106 may be a gNB.

The base station 104 supports a cell 124, and the base station 106 supports a cell 126. The cell 124 partially overlaps with the cell 126, so that the UE 102A can be in range to communicate with base station 104 while simultaneously being in range to communicate with the base station 106 (or in range to detect or measure signals from the base station 106). The overlap can make it possible for the UE 102A to hand over between the cells (e.g., from the cell 124 to the cell 126) or base stations (e.g., from the base station 104 to the base station 106) before the UE 102A experiences radio link failure, for example. Moreover, the overlap allows for various dual connectivity (DC) scenarios. For example, the UE 102A can communicate in DC with the base station 104 (operating as a master node (MN)) and the base station 106 (operating as a secondary node (SN)). When the UE 102A is in DC with the base station 104 and the base station 106, the base station 104 operates as a master eNB (MeNB), a master ng-eNB (Mng-eNB), or a master gNB (MgNB), and the base station 106 operates as a secondary gNB (SgNB) or a secondary ng-eNB (Sng-eNB).

In non-MBS (unicast) operation, the UE 102A can use a radio bearer (e.g., a DRB or an SRB) that at different times terminates at an MN (e.g., the base station 104) or an SN (e.g., the base station 106). For example, after handover or SN change to the base station 106, the UE 102A can use a radio bearer (e.g., a DRB or an SRB) that terminates at the base station 106. The UE 102A can apply one or more security keys when communicating on the radio bearer, in the uplink (from the UE 102A to a base station) and/or downlink (from a base station to the UE 102A) direction. In non-MBS operation, the UE 102A transmits data via the radio bearer on (i.e., within) an uplink (UL) bandwidth part (BWP) of a cell to the base station, and/or receives data via the radio bearer on a downlink (DL) BWP of the cell from the base station. The UL BWP can be an initial UL BWP or a dedicated UL BWP, and the DL BWP can be an initial DL BWP or a dedicated DL BWP. The UE 102A can receive paging, system information, public warning message(s), or a random access response on the DL BWP. In this non-MBS operation, the UE 102A can be in a connected state. Alternatively, the UE 102A can be in an idle or inactive state if the UE 102A supports small data transmission (which can also be referred to as “early data transmission”) in the idle or inactive state.

In MBS operation, the UE 102A can use an MBS radio bearer (MRB) that at different times terminates at an MN (e.g., the base station 104) or an SN (e.g., the base station 106). For example, after handover or SN change, the UE 102A can use an MRB that terminates at the base station 106, which can be operating as an MN or SN. In some scenarios, a base station (e.g., the MN or SN) can transmit MBS data over unicast radio resources (i.e., the radio resources dedicated to the UE 102A) to the UE 102A via the MRB. In other scenarios, the base station (e.g., the MN or SN) can transmit MBS data over multicast radio resources (i.e., the radio resources common to the UE 102A and one or more other UEs), or a DL BWP of a cell from the base station to the UE 102A via the MRB. The DL BWP can be an initial DL BWP, a dedicated DL BWP, or an MBS DL BWP (i.e., a DL BWP that is specific to MBS, or not for unicast).

The base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation of FIG. 1A includes an MBS controller 132 that is configured to manage or control transmission of MBS information received from the CN 110 or an edge server. For example, the MBS controller 132 can be configured to support radio resource control (RRC) configurations, procedures and messaging associated with MBS procedures, and/or other operations associated with those configurations and/or procedures, as discussed below. The processing hardware 130 can also include a non-MBS controller 134 that is configured to manage or control one or more RRC configurations and/or RRC procedures when the base station 104 operates as an MN or SN during a non-MBS operation.

The base station 106 includes processing hardware 140, which can include one or more general-purpose processors (e.g., CPUs) and a computer-readable memory storing machine-readable instructions executable on the general-purpose processor(s), and/or special-purpose processing units. The processing hardware 140 in the example implementation of FIG. 1A includes an MBS controller 142 and a non-MBS controller 144, which may be similar to the controllers 132 and 134, respectively, of base station 130. Although not shown in FIG. 1A, the RAN 105 can include additional base stations with processing hardware similar to the processing hardware 130 of the base station 104 and/or the processing hardware 140 of the base station 106.

The UE 102A includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes an MBS controller 152 that is configured to manage or control reception of MBS information. For example, the MBS controller 152 can be configured to support RRC configurations, procedures and messaging associated with MBS procedures, and/or other operations associated with those configurations and/or procedures, as discussed below. The processing hardware 150 can also include a non-MBS controller 154 configured to manage or control one or more RRC configurations and/or RRC procedures in accordance with any of the implementations discussed below, when the UE 102A communicates with an MN and/or an SN during a non-MBS operation. Although not shown in FIG. 1A, the UEs 102B, 103 may each include processing hardware similar to the processing hardware 150 of the UE 102A.

The CN 110 may be an evolved packet core (EPC) 111 or a fifth-generation core (5GC) 160, both of which are depicted in FIG. 1A. The base station 104 may be an eNB supporting an S1 interface for communicating with the EPC 111, an ng-eNB supporting an NG interface for communicating with the 5GC 160, or a gNB that supports an NR radio interface as well as an NG interface for communicating with the 5GC 160. The base station 106 may be an EUTRA-NR DC (EN-DC) gNB (en-gNB) with an S1 interface to the EPC 111, an en-gNB that does not connect to the EPC 111, a gNB that supports the NR radio interface and an NG interface to the 5GC 160, or a ng-eNB that supports an EUTRA radio interface and an NG interface to the 5GC 160. To directly exchange messages with each other during the scenarios discussed below, the base stations 104 and 106 may support an X2 or Xn interface.

Among other components, the EPC 111 can include a serving gateway (SGW) 112, a mobility management entity (MME) 114, and a packet data network gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from a UE (e.g., UE 102A or 102B) to one or more external packet data networks, e.g., an Internet network and/or an Internet Protocol (IP) Multimedia Subsystem (IMS) network. The 5GC 160 includes a user plane function (UPF) 162 and an access and mobility management (AMF) 164, and/or a session management function (SMF) 166. The UPF 162 is generally configured to transfer user-plane packets related to audio calls, video calls, Internet traffic, etc., the AMF 164 is generally configured to manage authentication, registration, paging, and other related functions, and the SMF 166 is generally configured to manage PDU sessions.

The UPF 162, AMF 164, and/or SMF 166 can be configured to support MBS. For example, the SMF 166 can be configured to manage or control MBS transport, configure the UPF 162 and/or RAN 105 for MBS flows, and/or manage or configure one or more MBS sessions or PDU sessions for MBS for a UE (e.g., UE 102A or 102B). The UPF 162 is configured to transfer MBS data packets to audio, video, Internet traffic, etc. to the RAN 105. The UPF 162 and/or SMF 166 can be configured for both non-MBS unicast service and MBS, or for MBS only.

Generally, the wireless communication system 100 may include any suitable number of base stations supporting NR cells and/or EUTRA cells. More particularly, the EPC 111 or the 5GC 160 may be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies, such as sixth generation (6G) radio access and/or 6G core network or 5G NR-6G DC, for example.

In different configurations or scenarios of the wireless communication system 100, the base station 104 can operate as an MeNB, an Mng-eNB, or an MgNB, and the base station 106 can operate as an SgNB or an Sng-eNB. The UE 102A can communicate with the base station 104 and the base station 106 via the same radio access technology (RAT), such as EUTRA or NR, or via different RATs.

When the base station 104 is an MeNB and the base station 106 is an SgNB, the UE 102A can be in EN-DC with the MeNB 104 and the SgNB 106. When the base station 104 is an Mng-eNB and the base station 106 is an SgNB, the UE 102A can be in next generation (NG) EUTRA-NR DC (NGEN-DC) with the Mng-eNB 104 and the SgNB 106. When the base station 104 is an MgNB and the base station 106 is an SgNB, the UE 102A can be in NR-NR DC (NR-DC) with the MgNB 104 and the SgNB 106. When the base station 104 is an MgNB and the base station 106 is an Sng-eNB, the UE 102A can be in NR-EUTRA DC (NE-DC) with the MgNB 104 and the Sng-eNB 106.

FIG. 1B depicts an example distributed implementation of each of one or both of the base stations 104 and 106. In this implementation, the base station 104, 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include some or all of the processing hardware 130 or 140 of FIG. 1A.

Each of the DU(s) 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 104) operates as an MN or an SN. The processing hardware can also include a physical (PHY) layer controller configured to manage or control one or more PHY layer operations or procedures.

In some implementations, the CU 172 can include one or more logical nodes (CU-CP(s) 172A) that host the control plane part of the Packet Data Convergence Protocol (PDCP) protocol of the CU 172 and/or the radio resource control (RRC) protocol of the CU 172. The CU 172 can also include one or more logical nodes (CU-UP(s) 172B) that host the user plane part of the PDCP protocol and/or service data adaptation protocol (SDAP) protocol of the CU 172. The CU-CP(s) 172A can transmit non-MBS control information and MBS control information, and the CU-UP(s) 172B can transmit non-MBS data packets and MBS data packets, as described herein.

The CU-CP(s) 172A can be connected to multiple CU-UPs 172B through the E1 interface. The CU-CP(s) 172A select the appropriate CU-UP(s) 172B for the requested services for the UE 102A. In some implementations, a single CU-UP 172B can be connected to multiple CU-CPs 172A through the E1 interface. A CU-CP 172A can be connected to one or more DUs 174s through an F1-C interface. A CU-UP 172B can be connected to one or more DUs 174 through an F1-U interface under the control of the same CU-CP 172A. In some implementations, one DU 174 can be connected to multiple CU-UPs 172B under the control of the same CU-CP 172A. In such implementations, the connectivity between a CU-UP 172B and a DU 174 is established by the CU-CP 172A using bearer context management functions.

The description above regarding UE 102A can also apply to the UE 102B and/or the UE 103.

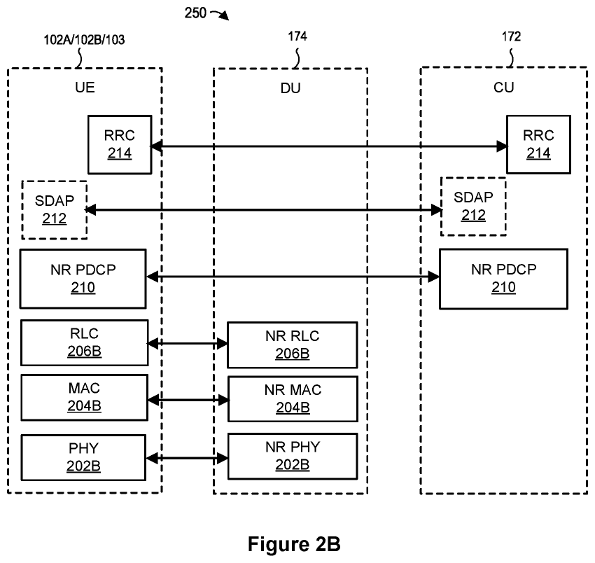

FIG. 2A illustrates, in a simplified manner, an example protocol stack 200 according to which a UE (e.g., UE 102A, 102B, or 103) can communicate with an eNB/ng-eNB or a gNB/en-gNB (e.g., one or both of the base stations 104, 106). In the example protocol stack 200, a PHY sublayer 202A of EUTRA provides transport channels to an EUTRA MAC sublayer 204A, which in turn provides logical channels to an EUTRA RLC sublayer 206A. The EUTRA RLC sublayer 206A in turn provides RLC channels to an EUTRA PDCP sublayer 208 and, in some cases, to an NR PDCP sublayer 210. Similarly, an NR PHY 202B provides transport channels to an NR MAC sublayer 204B, which in turn provides logical channels to an NR RLC sublayer 206B. The NR RLC sublayer 206B in turn provides RLC channels to an NR PDCP sublayer 210. The UE, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE can support layering of NR PDCP 210 over EUTRA RLC 206A, and an SDAP sublayer 212 over the NR PDCP sublayer 210. Sublayers are also referred to herein as simply “layers.”

The EUTRA PDCP sublayer 208 and the NR PDCP sublayer 210 receive packets (e.g., from an IP layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, at times this disclosure for simplicity refers to both SDUs and PDUs as “packets.” The packets can be MBS packets or non-MBS packets. MBS packets may include application content for an MBS service (e.g., IPv4/IPv6 multicast delivery, IPTV, software delivery over wireless, group communications, IoT applications, V2X applications, and/or emergency messages related to public safety), for example. As another example, MBS packets may include application control information for the MBS service.

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 may be SDAP PDUs, IP packets, or Ethernet packets, for example.

In scenarios where the UE (e.g., UE 102A, 102B, or 103) operates in EN-DC with the base station 104 operating as an MeNB and the base station 106 operating as an SgNB, the wireless communication system 100 can provide the UE with an MN-terminated bearer that uses EUTRA PDCP sublayer 208, or an MN-terminated bearer that uses NR PDCP sublayer 210. The wireless communication system 100 in various scenarios can also provide the UE with an SN-terminated bearer, which uses only the NR PDCP sublayer 210. The MN-terminated bearer may be an MCG bearer, a split bearer, or an MN-terminated SCG bearer. The SN-terminated bearer may be an SCG bearer, a split bearer, or an SN-terminated MCG bearer. The MN-terminated bearer may be an SRB (e.g., SRB1 or SRB2) or a DRB. The SN-terminated bearer may be an SRB or a DRB.

In some implementations, a base station (e.g., base station 104 or 106) broadcasts MBS data packets via one or more MRBs, and in turn the UE receives the MBS data packets via the MRB(s). The base station can include configuration(s) of the MRB(s) in multicast configuration parameters (which can also be referred to as MBS configuration parameters) described below. In some implementations, the base station broadcasts the MBS data packets via RLC sublayer 206, MAC sublayer 204, and PHY sublayer 202, and correspondingly, the UE uses PHY sublayer 202, MAC sublayer 204, and RLC sublayer 206 to receive the MBS data packets. In such implementations, the base station and the UE may not use PDCP sublayer 208 and a SDAP sublayer 212 to communicate the MBS data packets. In other implementations, the base station transmits the MBS data packets via PDCP sublayer 208, RLC sublayer 206, MAC sublayer 204, and PHY sublayer 202, and correspondingly, the UE uses PHY sublayer 202, MAC sublayer 204, RLC sublayer 206 and PDCP sublayer 208 to receive the MBS data packets. In such implementations, the base station and the UE may not use a SDAP sublayer 212 to communicate the MBS data packets. In yet other implementations, the base station transmits the MBS data packets via the SDAP sublayer 212, PDCP sublayer 208, RLC sublayer 206, MAC sublayer 204, and PHY sublayer 202 and, correspondingly, the UE uses the PHY sublayer 202, MAC sublayer 204, RLC sublayer 206, PDCP sublayer 208, and SDAP sublayer 212 to receive the MBS data packets.

FIG. 2B illustrates, in a simplified manner, an example protocol stack 250 which the UE (e.g., UE 102A, 102B, or 103) can communicate with a DU (e.g., DU 174) and a CU (e.g., CU 172). The radio protocol stack 200 is functionally split as shown by the radio protocol stack 250 in FIG. 2B. The CU at either of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

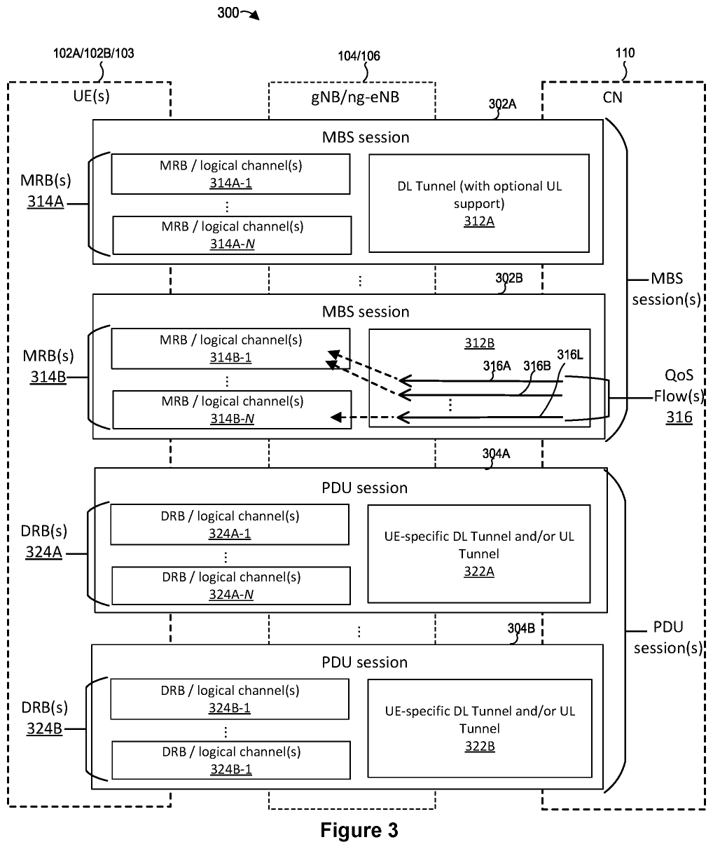

Referring next to FIG. 3, which depicts example architectures 300 for MBS sessions and PDU sessions, an MBS session 302A can include a tunnel 312A with endpoints at the CN 110 and the base station 104/106 (i.e., the base station 104 or the base station 106). The MBS session 302A can correspond to a certain session ID such as a Temporary Mobile Group Identity (TMGI), for example. The MBS data can include IP packets, TCP/IP packets, UDP/IP packets, Real-Time Transport Protocol (RTP)/UDP/IP packets, or RTP/TCP/IP packets, for example.

In some cases, the CN 110 and/or the base station 104/106 configure the tunnel 312A only for MBS traffic directed from the CN 110 to the base station 104/106, and the tunnel 312A can be referred to as a downlink (DL) tunnel. In other cases, however, the CN 110 and the base station 104/106 use the tunnel 312A for downlink as well as for uplink (UL) MBS traffic to support, for example, commands or service requests from UEs. Further, because the base station 104/106 can direct MBS traffic arriving via the tunnel 312A to multiple UEs, the tunnel 312A can be referred to as a common tunnel or a common DL tunnel.

The tunnel 312A can operate at the transport layer or sublayer, e.g., on the User Datagram Protocol (UDP) protocol layered over Internet Protocol (IP). As a more specific example, the tunnel 312A can be associated with the General Packet Radio System (GPRS) Tunneling Protocol (GTP). The tunnel 312A can correspond to a certain IP address (e.g., an IP address of the base station 104/106) and a certain Tunnel Endpoint Identifier (TEID) (e.g., assigned by the base station 104/106), for example. More generally, the tunnel 312A can have any suitable transport-layer configuration. The CN 110 can specify the IP address and the TEID address in header(s) of a tunnel packet including an MBS data packet and transmit the tunnel packet downstream to the base station 104/106 via the tunnel 312A. The header(s) can include the IP address and/or the TEID. For example, the header(s) includes an IP header and an GTP header including the IP address and the TEID, respectively. The base station 104/106 accordingly can identify data packets traveling via the tunnel 312A using the IP address and/or the TEID.

As illustrated in FIG. 3, the base station 104/106 maps traffic in the tunnel 312A to N radio bearers 314A-1, 314A-2, . . . 314A-N, which may be configured as MBS radio bearers or MRBs, where N≥1. Each MRB can correspond to a respective logical channel. As discussed above, the PDCP sublayer provides support for radio bearers such as SRBs, DRBs, and MRBs, and a EUTRA or NR MAC sublayer provides logical channels to a EUTRA or NR RLC sublayer. Each of the MRBs 314A for example can correspond to a respective MBS Traffic Channel (MTCH). The base station 104/106 and the CN 110 can also maintain another MBS session 302B, which similarly can include a tunnel 312B corresponding to MRBs 314B-1, 314B-2, . . . 314B-N, where N≥1. Each of the MRBs 314B can correspond to a respective logical channel.

The MBS traffic can include one or multiple quality-of-service (QoS) flows, for each of the tunnels 312A, 312B, etc. For example, the MBS traffic on the tunnel 312B can include a set of flows 316 including QoS flows 316A, 316B, . . . 316L, where L>1. Further, a logical channel of an MRB can support a single QoS flow or multiple QoS flows. In the example configuration of FIG. 3, the base station 104/106 maps the QoS flows 316A and 316B to the MTCH of the MRB 314B-1, and the QoS flow 316L to the MTCH of the MRB 314B-N.

In various scenarios, the CN 110 can assign different types of MBS traffic to different QoS flows. A flow with a relatively high QoS value can correspond to audio packets, and a flow with a relatively low QoS value can correspond to video packets, for example. As another example, a flow with a relatively high QoS value can correspond to I-frames or complete images used in video compression, and a flow with a relatively low Qos value can correspond to P-frames or predicted pictures that include only changes to I-frames.

With continued reference to FIG. 3, the base station 104/106 and the CN 110 can maintain one or more PDU sessions to support unicast traffic between the CN 110 and particular UEs. A PDU session 304A can include a UE-specific DL tunnel and/or UE-specific DL tunnel 322A corresponding to one or more DRBs 324A, such as a DRB 324A-1, 324A-2, . . . 324-N. Each of the DRBs 324A can correspond to a respective logical channel, such as a Dedicated Traffic Channel (DTCH).

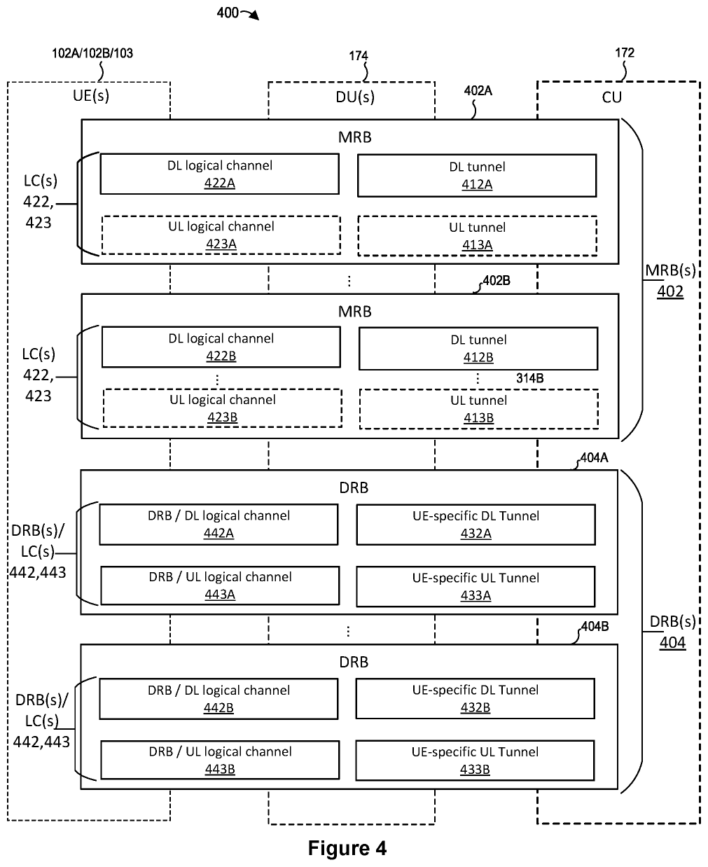

Now referring to FIG. 4, which depicts example MRB(s) and DRB(s) in the case where the base station 104/106 is implemented in a distributed manner, the CU 172 and the DU(s) 174 can establish tunnels for downlink data and/or uplink data associated with an MRB or a DRB. The MRB 314A-1 discussed above can be implemented as an MRB 402A connecting the CU 172 to multiple UEs such as the UE 102A and 102B, for example. The MRB 402A can include a DL tunnel 412A connecting the CU 172 and the DU(s) 174, and a DL logical channel 422A corresponding to the DL tunnel 412A. In particular, the DU(s) 174 can map downlink traffic received via the DL tunnel 412A to the DL logical channel 422A, which can be an MTCH or a DTCH, for example. The DL tunnel 412A can be a common DL tunnel via which the CU 172 transmits MBS data packets to multiple UEs.

Optionally, the MRB 402A also includes a UL tunnel 413A connecting the CU 172 and the DU(s) 174, and a UL logical channel 423A corresponding to the UL tunnel 413A. The UL logical channel 423A can be a PUCCH, for example. The DU(s) 174 can map uplink traffic received via the UL logical channel 423A to the UL tunnel 413A.

The tunnels 412A and 413A can operate at the transport layer or sublayer of the F1-U interface. As a more specific example, the CU 172 and the DU(s) 174 can utilize an F1-U for user-plane traffic, and the tunnels 412A and 413A can be associated with the GTP-U protocol layered over UDP/IP, where IP is layered over suitable data link and PHY layers. Further, the MRB(s) 402 and/or the DRB(s) 404 in at least some of cases additionally support control-plane traffic. More particularly, the CU 172 and the DU(s) 174 can exchange F1-AP messages over an F1-C interface that relies on a Stream Control Transmission Protocol (SCTP) layered over IP, where IP is layered over suitable data link and PHY layers similar to F1-U.

Similarly, an MRB 402B can include a DL tunnel 412B and, optionally, an UL tunnel 413B. The DL tunnel 412B can correspond to a DL logical channel 422B, and the UL tunnel 413B can correspond to the UL logical channel 423B.

The CU 172 in some cases uses a DRB 404A to transmit MBS data packets or unicast data packets associated with a PDU session, to a particular UE (e.g., the UE 102A or the UE 102B). The DRB 404A can include a UE-specific DL tunnel 432A connecting the CU 172 and the DU 174A/174B, and a DL logical channel 442A corresponding to the DL tunnel 432A In particular, the DU 174A/174B can map downlink traffic received via the DL tunnel 432A to the DL logical channel 442A, which can be a DTCH, for example. The DRB 404A further includes a UE-specific UL tunnel 433A connecting the CU 172 and the DU 174A/174B, and a UL logical channel 443A corresponding to the UL tunnel 433A. The UL logical channel 443A can be a PUSCH, for example. The DU 174A/174B can map uplink traffic received via the UL logical channel 443A to the UL tunnel 433A.

Similarly, A DRB 404B can include a UE-specific DL tunnel 432B corresponding to a DL logical channel 442B, and a UE-specific UL tunnel 433B corresponding to a UL logical channel 443B.

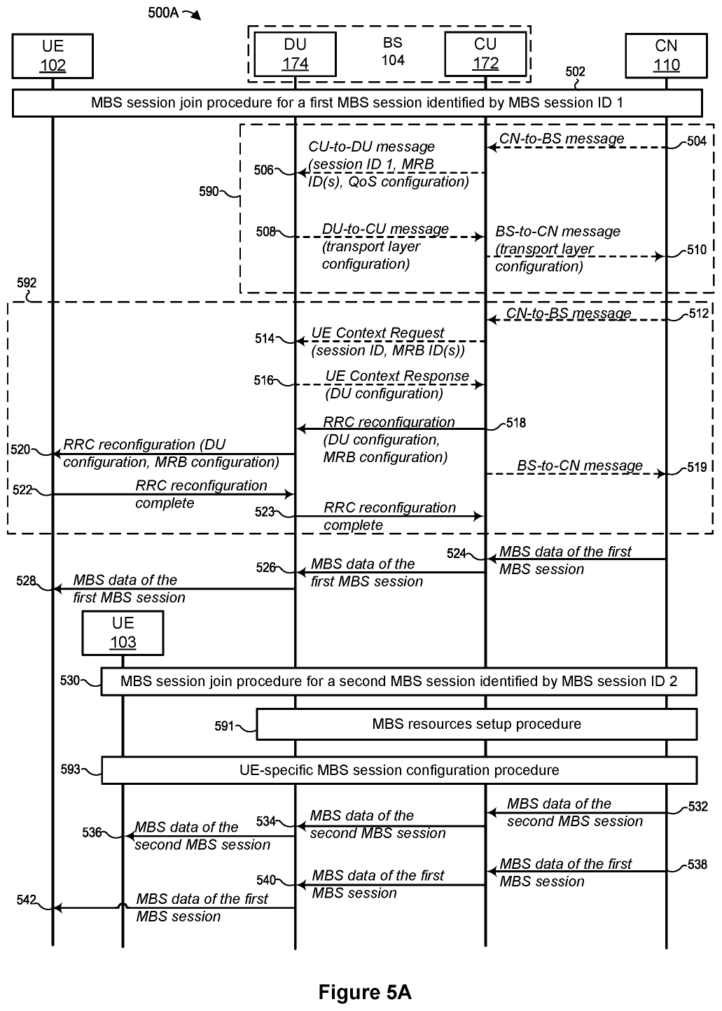

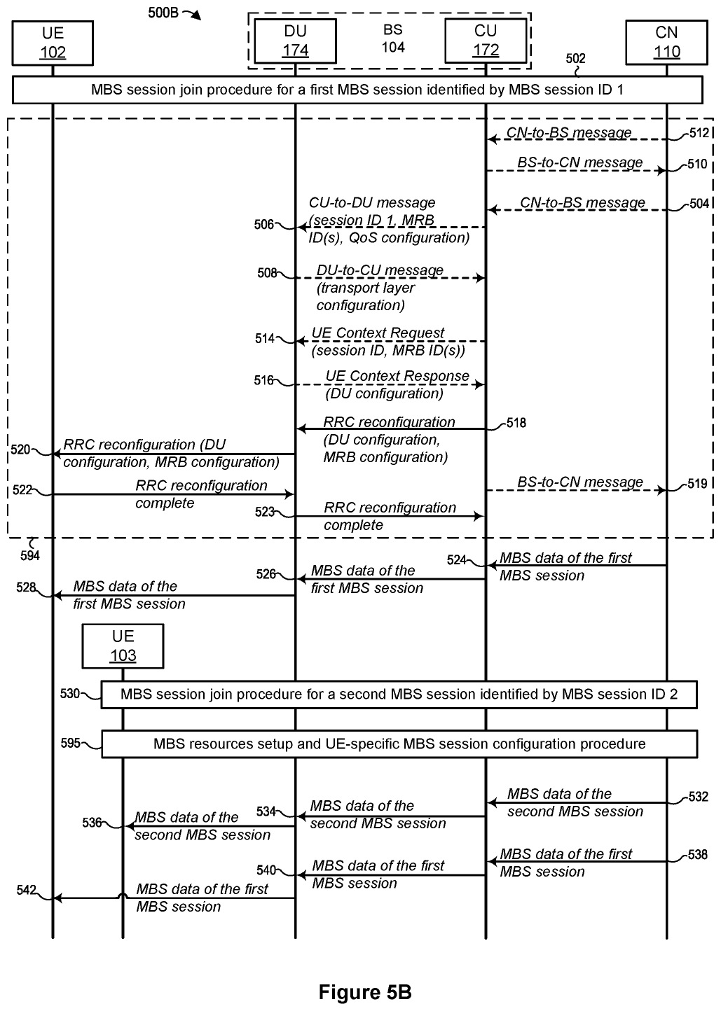

Referring now to FIG. 5A, in an example scenario 500A, the base station 104, including a CU 172 and a DU 174, configures resources for transmitting MBS data of an MBS session.

The UE 102 (i.e., one or both/each of the UEs 102A and 102B) initially performs a (first) MBS session join procedure 502 with the CN 110 via the base station 104 to join a certain MBS session (i.e., a first MBS session). Because the base station 104 configures a common DL tunnel for MBS traffic rather than a UE-specific tunnel, as discussed below, the procedures 502 and 590 can occur in either order. In other words, the base station 104 can configure a common DL tunnel before even a single UE joins the MBS session.

To perform the MBS session join procedure 502, the UE 102 in some implementations sends an MBS session join request message to the CN 110 via the base station 104. In response, the CN 110 can send an MBS session join response message to the UE 102 via the base station 104 to grant the UE 102 access to the first MBS session. In some implementations, the UE 102 can include a first MBS session ID (e.g., MBS session ID 1) of the first MBS session in the MBS session join request message. The CN 110 in some cases includes the first MBS session ID in the MBS session join response message. In some implementations, the UE 102 can send an MBS session join complete message to the CN 110 via the base station 104 in response to the MBS session join response message.

In some implementations, the MBS session join request message, MBS session join response message, and MBS session join complete message can be session initiation protocol (SIP) messages. In other implementations, the MBS session join request message, MBS session join response message, and MBS session join complete message can be NAS messages such as 5G mobility management (5GMM) messages or 5G session management messages (5GSM). In the case of the 5GSM messages, the UE 102 can transmit to the CN 110 (via the base station 104) a (first) UL container message including the MBS session join request message, the CN 110 can transmit to the UE 102 (via the base station 104) a DL container message including the MBS session join response message, and the UE 102 can transmit to the CN 110 via the base station 104 a (second) UL container message including the MBS session join complete message. These container messages can be 5GMM messages. In some implementations, the MBS session join request message, MBS session join response message, and MBS session join complete message can be a PDU Session Modification Request message, a PDU Session Modification Command message, and a PDU Session Modification Complete message, respectively. To simplify the following description, the MBS session join request message, the MBS session join response message, and/or the MBS session join complete message can represent the container messages.

In some implementations, the UE 102 can perform a PDU session establishment procedure with the CN 110 via the base station 104 to establish a PDU session in order to perform the (first) MBS session join procedure. During the PDU session establishment procedure, the UE 102 can communicate a PDU session ID of the PDU session with the CN 110 via the base station 104.

Before, during, or after the (first) MBS session join procedure 502, the CN 110 can send 504 a (first) CN-to-BS message including the first MBS session ID (e.g., MBS session ID 1) and/or the PDU session ID to the CU 172 to request the CU 172 to configure resources for the first MBS session. In response to receiving 504 the first CN-to-BS message, the CU 172 can send 506 a CU-to-DU message to the DU 174 to request a set-up for an MBS context and/or a common DL tunnel for the first MBS session. In response to receiving 506 the first CU-to-DU message, the DU 174 can send 508, to the CU 172, a DU-to-CU message including a first DU DL transport layer configuration to configure a common CU-to-DU DL tunnel for the first MBS session. In some implementations, the CU-to-DU message is a generic F1AP message or a dedicated F1AP message defined specifically to convey this type of a request (e.g., MBS Context Setup Request message). In some implementations, the DU-to-CU message of event 508 is a generic F1AP message or a dedicated F1AP message defined specifically for this purpose (e.g., MBS Context Setup Response message). The CN 110 can additionally include quality of service (QoS) configuration(s) for the first MBS session. In such cases, the CU 172 can include the QoS configuration(s) in the CU-to-DU message (event 506). In some implementations, the CU-to-DU message and DU-to-CU message can be non-UE-specific messages.

The CU 172 sends 510 a first BS-to-CN message (e.g., MBS Session Resource Setup Response message) in response to the message of event 504. The CU 172 can include the first MBS session ID and/or the PDU session ID in the first BS-to-CN message. The first BS-to-CN message can include a DL transport layer configuration to configure a common DL tunnel for the CN 110 to send MBS data to the CU 172. The DL transport layer configuration includes transport layer information, such as a transport layer address (e.g., an IP address) and/or a TEID, to identify the common DL tunnel. In some implementations, the CN-to-BS message of event 504 is a generic NGAP message or a dedicated NGAP message defined specifically for requesting resources for an MBS session (e.g., MBS Session Resource Setup Request message). In some implementations, the BS-to-CN message of event 510 is a generic NGAP message or a dedicated NGAP message defined specifically to convey resources for an MBS session (e.g., MBS Session Resource Setup Response message). In such cases, the CN-to-BS message of event 504 and the BS-to-CN message of event 510 can be non-UE-specific messages.

In some implementations, the QoS configuration(s) include QoS parameters for the MBS session. In some implementations, the QoS configuration includes configuration parameters to configure one or more QoS flows for the MBS session (see FIG. 3 and its description above). In some implementations, the configuration parameters include one or more QoS flow IDs identifying the QoS flow(s). Each of the QoS flow ID(s) identifies a particular QoS flow of the QoS flow(s). In some implementations, the configuration parameters include QoS parameters for each QoS flow. The QoS parameters can include a 5G QoS identifier (5QI), a priority level, a packet delay budget, a packet error rate, an averaging window, and/or a maximum data burst volume. The CN 110 can specify different values of the QoS parameters for the QoS flows.

The events 504, 506, 508, and 510 are collectively referred to in FIG. 5A as an MBS resource setup procedure 590.

In some implementations, the CN 110 can indicate, in the first CN-to-BS message, a list of UEs joining the first MBS session. In other implementations, the CN 110 can send 512 to the CU 172 a second CN-to-BS message indicating a list of UEs joining the first MBS session. The CN 110 can include the first MBS session ID and/or the PDU session ID in the second CN-to-BS message. The CU 172 can send 519 a second BS-to-CN message to the CN 110 in response to the second CN-to-BS message 512. In such cases, the second CN-to-BS message can be a non-UE-specific message, e.g., a message not specific for the UE 102A or the UE 102B. The CU 172 can include the first MBS session ID and/or the PDU session ID in the second BS-to-CN message. For example, the list of UEs may include the UE 102A and/or UE 102B. To indicate a list of UEs, the CN 110 can include a list of (CN UE interface ID, RAN UE interface ID) pairs, each identifying a particular UE of the UEs. The CN 110 assigns the CN UE interface ID, and the CU 172 assigns the RAN UE interface ID. Before the CN 110 sends the list of (CN UE interface ID, RAN UE interface ID) pairs, the CU 172 sends a BS-to-CN message (e.g., a NGAP message, an INITIAL UE MESSAGE or PATH SWITCH REQUEST message) including the RAN UE interface ID to the CN 110 for each of the UEs, and the CN 110 sends a CN-to-BS message (e.g., a NGAP message, an INITIAL CONTEXT SETUP REQUEST message or PATH SWITCH REQUEST ACKNOWLEDGE message) including the CN UE interface ID to the CU 172 for each of the UEs. In one example, the list of pairs includes a first pair of (a first CN UE interface ID and a first RAN UE interface ID) identifying the UE 102A and a second pair of (a second CN UE interface ID, a second RAN UE interface ID) identifying the UE 102B. In some implementations, the “CN UE interface ID” can be a “AMF UE NGAP ID” and the “RAN UE interface ID” can be a “RAN UE NGAP ID”. In other implementations, the CN 110 can include a list of UE IDs each identifying a particular UE of the UEs. In some implementations, the CN 110 can assign the UE IDs and send each of the UE IDs to a particular UE of the UEs in a NAS procedure (e.g., a registration procedure) that the CN 110 performs with the particular UE. For example, the list of UE IDs can include a first UE ID of the UE 102A and a second UE ID of the UE 102B. In some implementations, the UE IDs are S-Temporary Mobile Subscriber Identities (S-TMSIs) (e.g., 5G-S-TMSIs). Before the CN 110 sends the list of UE IDs, the CU 172 can receive the UE ID from the UE 102 or the CN 110 for each of the UEs. For example, the CU 172 can receive an RRC message (e.g., a RRCSetupComplete message) including the UE ID from the UE 102 during an RRC connection establishment procedure. In another example, the CU 172 can receive a CN-to-BS message (e.g., a NGAP message, an INITIAL CONTEXT SETUP REQUEST message or UE INFORMATION TRANSFER message) including the UE ID from the CN 110.

In other implementations, the CN 110 can send 512 to the CU 172 a second CN-to-BS message indicating (only) the UE 102 (i.e., either the UE 102A or the UE 102B) joins the first MBS session. The second CN-to-BS message can be a UE-associated message for the UE 102. That is, the second CN-to-BS message is specific for the UE 102. In response to receiving the second CN-to-BS message, the CU 172 can send 514 to the DU 174 a UE Context Request message for the UE 102. In some implementations, the CU 172 can include, in the UE Context Request message, the first MBS session ID and/or MRB ID(s) of MRB(s) associated to the first MBS session (ID). In response to the UE Context Request message, the DU 174 sends 516 to the CU 172 a UE Context Response message including configuration parameters for the UE 102 to receive MBS data of the first MBS session. In some implementations, the CU 172 can include the QoS configuration(s) in the UE Context Request message. In such cases, the CU 172 may or may not include the QoS configuration(s) in the CU-to-DU message. (Some of) the configuration parameters may be associated to the MRB(s)/MRB ID(s). In some implementations, the DU 174 generates a DU configuration to include the configuration parameters and includes the DU configuration in the UE Context Response message. In some implementations, the DU configuration can be a CellGroupConfig IE. In other implementations, the DU configuration can be an MBS-specific IE. In some implementations, the configuration parameters configure one or more logical channels (LCs). For example, the configuration parameters include one or more logical channel IDs (LCIDs) to configure the one or more logical channel. Each of the LCIDs identifies a particular logical channel of the one or more logical channels.

In some implementations, the second CN-to-BS message and the second BS-to-CN message can be a PDU Session Resource Modify Request message and a PDU Session Resource Modify Response message, respectively.

In some implementations, the CN 110 includes the QoS configuration(s) in the second CN-to-BS message. In such cases, the CN 110 may include the QoS configuration(s) in the first CN-to-BS message, or omit the QoS configuration(s). In some implementations, the DU 174 generates the configuration parameters for the UE 102 to receive MBS data of the first MBS session in response receiving the CU-to-DU message or the UE Context Request message. In some implementations, the CU 172 includes the QoS configuration(s) in the UE Context Request message and/or the CU-to-DU message. The DU 174 can determine the content of the configuration parameters in accordance with the QoS configuration(s). When the CU 172 includes the QoS configuration(s) in neither the CU-to-DU message nor the UE Context Request message, the DU 174 can determine values of the configuration parameters in accordance with a predetermined QoS configuration.

In some implementations, the UE Context Request message and the UE Context Response message are a UE Context Setup Request message and a UE Context Setup Response message, respectively. In other implementations, the UE Context Request message and the UE Context Response message are a UE Context Modification Request message and a UE Context Modification Response message, respectively.

After receiving 516 the UE Context Response message, the CU 172 generates an RRC reconfiguration message including the configuration parameters and one or more MRB configurations and transmits 518 the RRC reconfiguration message to the DU 174. In turn, the DU 174 transmits 520 the RRC reconfiguration message to the UE 102. In response, the UE 102 then transmits 522 an RRC reconfiguration complete message to the DU 174, which in turn transmits 523 the RRC reconfiguration complete message to the CU 172.

In some implementations, the CU 172 generates a PDCP PDU including the RRC reconfiguration message and sends 518 a CU-to-DU message including the PDCP PDU to the DU 174, and the DU 174 retrieves the PDCP PDU from the CU-to-DU message and transmits 520 the PDCP PDU to the UE 102 via the RLC layer 206B, MAC layer 204B, and PHY layer 202B. The UE 102 receives 520 the PDCP PDU from the DU 174 via the PHY layer 202B, MAC layer 204B, and RLC layer 206B. In some implementations, the UE 102 generates a PDCP PDU including the RRC reconfiguration complete message and transmits 522 the PDCP PDU to the DU 174 via the RLC layer 206B, MAC layer 204B, and PHY layer 202B. The DU 174 receives 522 the PDCP PDU from the UE 102 via the PHY layer 202B, MAC layer 204B, and RLC layer 206B and sends 523 a DU-to-CU including the PDCP PDU to the CU 172. The CU 172 retrieves the PDCP PDU from the DU-to-CU message and retrieves the RRC reconfiguration complete message from the PDCP PDU.

Before or after receiving 516 the UE Context Response message, the CU 172 can send 519 a second BS-to-CN message to the CN 110 in response to the second CN-to-BS message 512. In some implementations, the CU 172 sends 519 the second BS-to-CN message to the CN 110 before receiving 523 the RRC reconfiguration complete message. In other implementations, the CN 110 sends 519 the second BS-to-CN message to the CN 110 after receiving 523 the RRC reconfiguration complete message. The CU 172 can include the first CN UE interface ID and the first RAN UE interface ID in the second BS-to-CN message. Alternatively, the CU 172 can include the first UE ID in the second BS-to-CN message.

The events 512, 514, 516, 518, 519, 520, 522, and 523 are collectively referred to in FIG. 5A as a UE-specific MBS session resource configuration procedure 592. In some implementations, respective instances of the events 512, 514, 516, 518, 519, 520, 522, and 523 occur for each of the UE 102A and the UE 102B. The configuration parameters for the UE 102A and the UE 102B to receive MBS data of the first MBS session can be the same. In some implementations, the MBS session join procedure 502 include the UE-specific MBS session resource setup procedure 592. In such cases, the CN 110 can include the MBS session join response message for the UE 102 in the second CN-to-BS message.

In some implementations, the CU 172 can include the CU DL transport layer configuration(s) in the second BS-to-CN message. In other words, the CU 172 can send the same CU DL transport layer configuration(s) in BS-to-CN messages in responses to CN-to-BS messages indicating UEs joining the same MBS session. Similarly, the DU 174 can include the first DU DL transport layer configuration(s) in the UE Context Response message. In other words, the DU 174 can send the same DU DL transport layer configuration(s) in DU-to-CU messages in responses to CU-to-DU messages indicating UEs joining the same MBS session. In such implementations, the CN 110 can join/blend the MBS resource setup procedure 590 and the second CN-to-BS and BS-to-CN messages into a single procedure.

In cases where the CU 172 performs the MBS resource setup procedure 590 (e.g., events 504, 510) with the CN 110 to establish the common CN-to-BS DL tunnel for the first MBS session, the CU 172 may refrain from including a DL transport layer configuration for the first MBS session in the second BS-to-CN message. In such cases, the CN 110 may refrain from including a UL transport layer configuration for the first MBS session in the second CN-to-BS message. In cases where the DU 174 performs the MBS resource setup procedure 590 (e.g., events 506, 508) with the CU 172 to establish the common CU-to-DU DL tunnel for the first MBS session, the DU 174 may refrain from including a DL transport layer configuration for the first MBS session in the UE Context Response message. In such cases, the CU 172 may refrain from including a UL transport layer configuration for the first MBS session in the UE Context Request message.

After receiving 510 the first BS-to-CN message or 519 the second BS-to-CN message, the CN 110 can send 524 MBS data (e.g., one or multiple MBS data packets) to the CU 172 via the common CN-to-BS DL tunnel (i.e., the first common CN-to-BS DL tunnel), which in turn sends the 526 the MBS data to the DU 174 via the common CU-to-DU DL tunnel (i.e., the first common CU-to-DU DL tunnel). The DU 174 transmits (e.g., multicast or unicast) 528 the MBS data via the one or more logical channels to the UE 102 (i.e., the UE 102A and/or the UE 102B). The UE 102 receives 528 the MBS data via the one or more logical channels. For example, the CU 172 receives 524 an MBS data packet, generates a PDCP PDU including the MBS data packet and transmits 526 the PDCP PDU to the DU 174. In turn, the DU 174 generates a MAC PDU including the logical channel ID and the PDCP PDU, and transmits 528 the MAC PDU to the UE 102 via multicast or unicast. The UE 102 receives 528 the MAC PDU via multicast or unicast, retrieves the PDCP PDU and the logical channel ID from the MAC PDU, identifies the PDCP PDU associated with the MRB, and retrieves the MBS data packet from the PDCP PDU.

In some implementations, the one or more MRB configurations configuring one or more MRBs are associated with the first MBS session. In some implementations, the configuration parameters also include one or more RLC bearer configurations, each associated with a particular MRB. Each of the MRB configuration(s) can include a MRB ID, a PDCP configuration, the first MBS session ID, a PDCP reestablishment indication (e.g., reestablishPDCP), and/or a PDCP recovery indication (e.g., recoveryPDCP). In some implementations, the PDCP configuration can be a PDCP-Config IE for DRB. In some implementations, the RLC bearer configuration can be an RLC-BearerConfig IE. In some implementations, the RLC bearer configuration may include a logical channel (LC) ID configuring a logical channel. In some implementations, the logical channel can be a multicast traffic channel (MTCH). In other implementations, the logical channel can be a dedicated traffic channel (DTCH). In some implementations, the configuration parameters may include logical channel configuration (e.g., LogicalChannelConfig IE) configuring the logical channel. In some implementations, the RLC bearer configuration may include the MRB ID.

In some implementations, the CU 172 can configure the MRB as a DL-only RB in the MRB configuration. For example, the CU 172 refrains from including UL configuration parameters in the PDCP configuration within the MRB configuration to configure the MRB as a DL only RB. The CU 172 only includes DL configuration parameters in the MRB configuration, e.g., as described above. In such cases, the CU 172 configures the UE 102 not to transmit UL PDCP data PDU via the MRB to the DU 174 and/or the CU 172 by excluding the UL configuration parameters for the MRB in the PDCP configuration in the MBR configuration. In another example, the DU 174 refrains from including UL configuration parameters in the RLC bearer configuration. In such cases, the DU 174 configures the UE 102 not to transmit control PDU(s) via the logical channel to the DU 174 by excluding the UL configuration parameters from the RLC bearer configuration.

In cases where the DU 174 includes UL configuration parameter(s) in the RLC bearer configuration, the UE 102 may transmit control PDU(s) (e.g., PDCP Control PDU(s) and/or RLC Control PDU(s)) via the logical channel to the DU 174 using the UL configuration parameter(s). If the control PDU is a PDCP control PDU, the DU 174 can send the PDCP control PDU to the CU 172. For example, the CU 172 may configure the UE 102 to receive MBS data with a (de) compression protocol (e.g., robust header compression (ROHC) protocol), e.g., in the MRB configuration. In this case, when the CU 172 receives 524 an MBS data packet from the CN 110, the CU 172 compresses the MBS data packet with the compression protocol to obtain a compressed MBS data packet and transmits 526 a PDCP PDU including the compressed MBS data packet to the DU 174 via the common CU-to-DU DL tunnel. In turn, the DU 174 transmits (e.g., multicast or unicast) 528 the PDCP PDU to the UE 102 via the logical channel. When the UE 102 receives the PDCP PDU via the logical channel, the UE 102 retrieves the compressed MBS data packet from the PDCP PDU. The UE 102 decompresses the compressed MBS data packet with the (de) compression protocol to obtain the original MBS data packet. In such cases, the UE 102 may transmit a PDCP Control PDU including, a header compression protocol feedback (e.g., interspersed ROHC feedback) for operation of the header (de) compression protocol, via the logical channel to the DU 174. In turn, the DU 174 sends the PDCP Control PDU to the CU 172 via a UE-specific UL tunnel, i.e., the UL tunnel is specific for the UE 102 (e.g., the UE 102A). In some implementations, the CU 172 can include, in the UE Context Request message, a CU UL transport layer configuration configuring the UE-specific UL tunnel. The CU UL transport layer configuration includes a CU transport layer address (e.g., an Internet Protocol (IP) address) and a CU UL TEID to identify the UE-specific UL tunnel.

In some implementations, the MRB configuration can be an MRB-ToAddMod IE including an MRB ID (e.g., mrb-Identity or MRB-Identity). A MRB ID identifies a particular MRB of the MRB(s). The CU 172 sets the MRB IDs to different values. In cases where the CU 172 has configured DRB(s) to the UE 102 for unicast data communication, the CU 172 in some implementations can set the MRB ID(s) to values different from DRB ID(s) of the DRB(s). In such cases, the UE 102 and the CU 172 can distinguish whether an RB is a MRB or DRB in accordance an RB ID of the RB. In other implementations, the CU 172 can set one or more of the MRB ID(s) to values which can be the same as one or more of the DRB ID(s). In such cases, the UE 102 and the CU 172 can distinguish whether an RB is a MRB or DRB in accordance an RB ID of the RB and a RRC IE configuring the RB. For example, a DRB configuration configuring a DRB is a DRB-ToAddMod IE including a DRB identity (e.g., drb-Identity or DRB-Identity) and a PDCP configuration. Thus, the UE 102 can determine an RB is an DRB if the UE 102 receives a DRB-ToAddMod IE configuring the RB, and determine an RB is a MRB if the UE 102 receives an MRB-ToAddMod IE configuring the RB. Similarly, the CU 172 can determine an RB is an DRB if the CU 172 transmits a DRB-ToAddMod IE configuring the RB to the UE 102, and determine an RB is a MRB if the CU 172 transmits an MRB-ToAddMod IE configuring the RB to the UE 102.

In some implementations, the configuration parameters for receiving MBS data of the first MBS session include one or more logical channel (LC) IDs to configure one or more logical channels. In some implementations, the logical channel(s) can be DTCH(s). In other implementations, the logical channel(s) can be MTCH(s). In some implementations, the configuration parameters may or may not include a group radio network temporary identifier (G-RNTI). The RRC reconfiguration messages for UEs (e.g., the UE 102A and the UE 102B) joining the first MBS session, include the same configuration parameters for receiving MBS data of the first MBS session. In some implementations, the RRC reconfiguration messages for the UEs may include the same or different configuration parameters for receiving non-MBS data.

In some implementations, the CU 172 can include the MBS session join response message in the RRC reconfiguration message. The UE 102 can include the MBS session join complete message in the RRC reconfiguration complete message. Alternatively, the UE 102 can send a UL RRC message including the MBS session join complete message to the CU 172 via the DU 174. The UL RRC message can be a ULInformationTransfer message or any suitable RRC message that can include a UL NAS PDU. The CU 172 can include the MBS session join complete message in the second BS-to-CN message. Alternatively, the CU 172 can send to the CN 110 a BS-to-CN message (e.g., an UPLINK NAS TRANSPORT message) including the MBS session join complete message.

In other implementations, the CU 172 transmits a DL RRC message that MBS session join response message to the UE 102 via the DU 174. The DL RRC message can be a DLInformation Transfer message, another RRC reconfiguration message, or any suitable RRC message that can include a DL NAS PDU. The UE 102 can send a UL RRC message including the MBS session join complete message to the CU 172 via the DU 174. The UL RRC message can be a ULInformationTransfer message, another RRC reconfiguration complete message or any suitable RRC message that can include a UL NAS PDU.

With continued reference to FIG. 5A, the UE 103 (and possibly also each of one or more other UEs not shown in FIG. 1A) can perform an MBS session join procedure 530 to join a second MBS session identified by a second MBS session ID (e.g., MBS session ID 2), similar to the procedure 502 discussed above. The base station 104 can perform an MBS session resources setup procedure 591 with the CN 110 to configure a second common CN-to-BS DL tunnel and a second common CU-to-DU DL tunnel for the second MBS session, similar to the procedure 590. The base station 104 can perform a UE-specific MBS session configuration procedure 593 with the UE 103 and the CN 110 to transmit to the UE 103 configuration parameters and one or more MRB configurations for the second MBS session, similar to the procedure 590. Some or all of the configuration parameters and the MRB configuration(s) of the procedure 593 may be different from the configuration parameters and the MRB configuration(s) of the procedure 592. For example, the configuration parameters of the procedure 593 may include a second G-RNTI (value) different from the G-RNTI (value) within the configuration parameters of the procedure 592. In another example, the MRB configuration(s) of the procedure 593 may include MRB ID(s) different from the MRB ID(s) within the configuration parameters of the procedure 592.

After the UE 103 has joined (at event 530) the second MBS session and obtained the necessary RRC configuration, and after the CN 110 performs 591 the procedure, the CN 110 can send 532 MBS data (e.g., one or multiple MBS data packets) to the CU 172 via the second common CN-to-BS DL tunnel, similar to event 524. In turn, the CU 172 sends 534 the MBS data to the DU 174 via the second common CU-to-DU DL tunnel, similar to event 526. The DU 174 transmits (e.g., multicast or unicast) 536 the MBS data via the one or more logical channels to the UE 103 (and possibly also each of one or more other UEs not shown in FIG. 1A), similar to event 528. The UE 103 (and possibly other UE(s)) receives 536 the MBS data via the one or more logical channels, similar to event 528.

After the CU 172 performs the procedure 591 with the CN 110 and the DU 174, and the UE 103 has joined (at event 530) the second MBS session and obtained the necessary RRC configuration, the CU 172 continues to receive 538 MBS data via the first common CN-to-BS DL tunnel and transmits 540 the MBS data to the DU 174 via the first common CU-to-DU DL tunnel. In some implementations, the DU 174 transmits 542 the MBS data to the UE 102A and UE 102B via multicast, similar to event 528. The UE 102 (e.g., 102A and UE 102B) can receive 542 MBS data similar to event 528. Alternatively, the base station 104 can transmit the MBS data to UEs of UE 102 (including UE 102A and UE 102B) separately via unicast, similar to event 528. In this case, the UE 102A and UE 102B can receive 542 MBS data separately via unicast, similar to event 528.

Referring next to FIG. 5B, a scenario 500B is depicted which is generally similar to the scenario 500A. Events in this scenario similar to those discussed above are labeled with the same reference numbers, and the examples and implementations for FIG. 5A can apply to FIG. 5B. The differences between the scenarios of FIG. 5A and FIG. 5B are discussed below.

In some implementations, the CU 172 can perform an MBS session resource setup procedure (i.e., events 510 and 504) with the CN 110 in response to receiving 512 the second CN-to-BS message. In such implementations, the CU 172 transmits 510 the first BS-to-CN message to the CN 110 in response to receiving 512 the second CN-to-BS message. The CN 110 transmits 504 the first CN-to-BS message to the CU 172 in response to receiving 510 the first BS-to-CN message. In such cases, the CN 110 may or may not include an MBS session ID (i.e., the first MBS session ID) in the first CN-to-BS message. The CN 110 can transmit 519 the BS-to-CN message in response to or after receiving 512 the second CN-to-BS message or 504 the first CN-to-BS message. After or in response to receiving 512 the second CN-to-BS message, transmitting 510 the second BS-to-CN message, or receiving 504 the first CN-to-BS message, the CU 172 can transmit 506 the CU-to-DU message to the DU 174.

The events 512, 510, 504, 506, 508, 514, 516, 518, 519, 520, 522, and 523 are collectively referred to in FIG. 5B as an MBS resource setup and UE-specific MBS session configuration procedure 594. The base station 104 can perform an MBS resource setup and UE-specific MBS session configuration procedure with the UE 103 and the CN 110, to transmit to the UE 103 configuration parameters and one or more MRB configurations for the second MBS session, similar to the procedure 594.

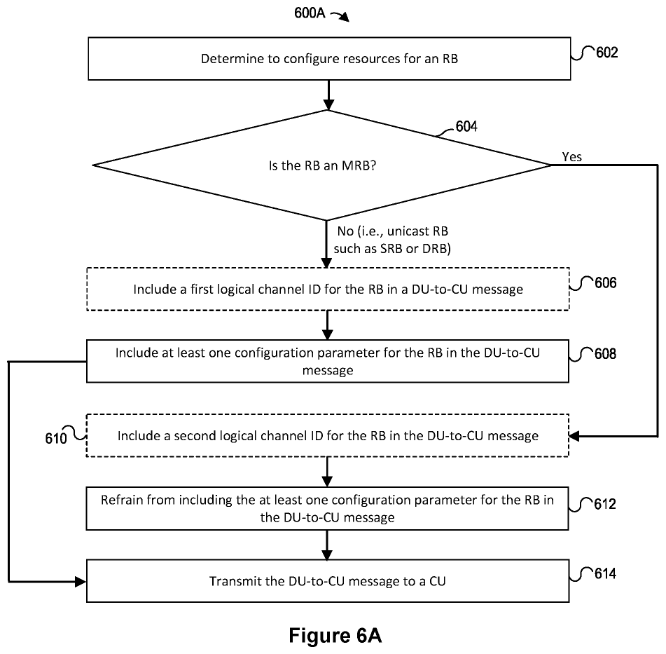

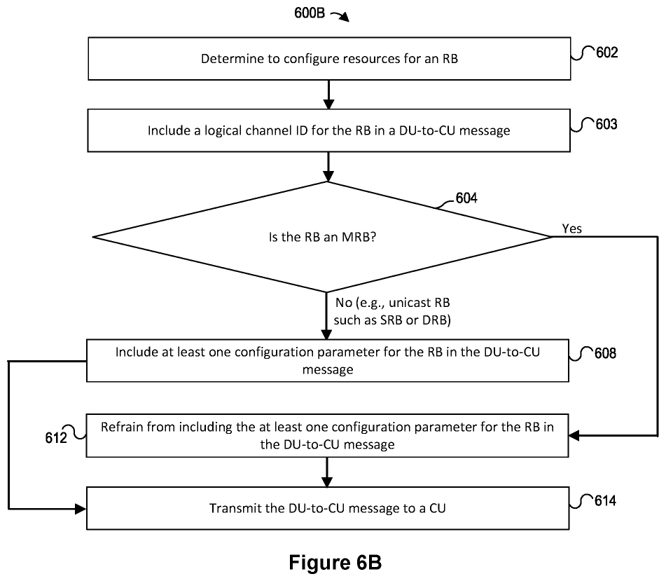

Next, several example methods that devices illustrated in FIGS. 1A and 1B can implement in certain scenarios are discussed with reference to FIGS. 6A-14. Each of these methods can be implemented by one or more processors executing a set of instructions stored on a non-transitory computer-readable medium.

Referring first to FIG. 6A, a DU such as the DU 174 can implement/perform a method 600A to determine whether to configure at least one configuration parameter for a radio bearer (RB). The method 600A begins at block 602, where the DU determines to configure resources for an RB (e.g., events 506, 514, 593). At block 604, the DU determines whether the RB is an MRB. If the RB is not an MRB (i.e., if the RB is a unicast RB such as an SRB or a DRB), the flow proceeds to block 606. At block 606, the DU includes a first logical channel ID for the RB in a DU-to-CU message. At block 608, the DU includes at least one configuration parameter for the RB in the DU-to-CU message. If the RB is an MRB, the flow instead proceeds to block 610. At block 610, the DU includes a second logical channel ID for the RB in the DU-to-CU message (e.g., events 508, 516, 593). At block 612, the DU refrains from including the at least one configuration parameter for the RB in the DU-to-CU message (e.g., events 508, 516, 593). At block 614, the DU transmits the DU-to-CU message to a CU (e.g., events 508, 516, 593).

In some implementations, the first and second logical channel IDs can be the same logical channel ID. In other implementations, the first and second logical channel IDs can be different logical channel IDs. In some implementations, the DU can set the first and second logical channel IDs to the same value. In other implementations, the DU can set the first and second logical channel IDs to different values.

In some implementations, the DU receives a CU-to-DU message from the CU (e.g., events 506, 514, 593). The CU can indicate the RB is a unicast RB (e.g., DRB or SRB) or an MRB in the CU-to-DU message. In some implementations, the CU can include an RB ID of the RB in the CU-to-DU message. In cases where the RB is an MRB, the RB ID can be a MRB ID. In cases where the RB is an SRB, the RB ID can be an SRB ID. In cases where the RB is a DRB, the RB ID is a DRB ID. In response to the CU-to-DU message, the DU determines to configure resources for the RB. Depending on whether the RB is an MRB or a unicast RB (e.g., DRB or SRB), the DU obtains different configuration parameters (e.g., logical channel ID and/or at least one other configuration parameter) and includes the different configuration parameters in the DU-to-CU message as described above. The DU then transmits the DU-to-CU message to the CU in response to the CU-to-DU message. In some implementations, the DU can determine the RB is an MRB, an SRB, or a DRB in accordance with the MRB indication, SRB indication, or DRB indication, respectively, for the RB. In other implementations, the DU can determine the RB is an MRB, an SRB, or a DRB in accordance with the MRB ID, SRB ID, or DRB ID, respectively.

In some implementations, the CU-to-DU message and the DU-to-CU message can be F1 application protocol (F1AP) messages. In some implementations, the CU-to-DU message and the DU-to-CU message can be a UE Context Setup Request message and a UE Context Setup Response message, respectively. In other implementations, the CU-to-DU message and the DU-to-CU message can be a UE Context Modification Request message and a UE Context Modification Response message, respectively. In yet other implementations, the CU-to-DU message and the DU-to-CU message can be an MBS Context Setup Request message and an MBS Context Setup Response message, respectively. In yet other implementations, the CU-to-DU message and the DU-to-CU message can be an MBS Context Modification Request message and an MBS Context Modification Response message, respectively.

In cases where the RB is an MRB, a CU (e.g., CU 172) generates a first DL message including the first logical channel ID (value) and the at least one configuration parameter and transmits the DL message to a UE via the DU. In other words, the DU can transmit the first logical channel ID (value) and the at least one configuration parameter to a first UE via the CU. In some implementations, the CU can generate an MRB configuration including the MRB ID and/or PDCP configuration parameters for the MRB and include the MRB configuration in the DL message. In cases where the RB is a unicast RB, the CU generates a second DL message including the second logical channel ID (value) and transmits the second DL message to a second UE via the DU. In some implementations, the CU can generate a unicast RB configuration (e.g., SRB configuration or DRB configuration) including a unicast RB ID (e.g., the SRB ID or DRB ID) and/or PDCP configuration parameters for the unicast RB and include the unicast RB configuration in the second DL message. The first and second UEs can be the same UE or different UEs. In some implementations, the first and second DL messages are RRC reconfiguration messages (e.g., RRCReconfiguration messages).

In some implementations, the at least one configuration parameter includes a logical channel configuration (e.g., mac-LogicalChannelConfig field or LogicalChannelConfig IE). In other implementations, the at least one configuration parameter includes uplink configuration parameters for a MAC layer (e.g., ul-SpecificParameters field). In yet other implementations, the at least one configuration parameter includes a logical channel group (e.g., logicalChannelGroup field), a subcarrier spacing list (e.g., allowedSCS-List field), a scheduling request ID (e.g., schedulingRequestedID field or SchedulingRequestedId IE), a timer value (e.g., bitRateQueryProhibitTimer field), a physical priority index (e.g., allowedPHY-PriorityIndex field), a channel access priority (e.g., channelAccessPriority field), and/or a bitrate multiplier (e.g., a bitRateMultiplier field).

In some implementations, the DU can transmit at least one first uplink configuration parameter for a physical layer to the UE, e.g., via the CU. When the UE receives a PDSCH transmission including a PDU associated with the RB (i.e., unicast RB), the UE can transmit a HARQ feedback to the RAN node in accordance with the at least one first configuration parameter. For example, the at least one first configuration parameter can include a PUCCH configuration (e.g., PUCCH-Config IE). In another example, the at least one first configuration parameter can include at least one PUCCH resource configuration, which can include or configure one or more PUCCH resources (e.g., PUCCH-Resource IE(s)) and/or one or more PUCCH resource sets (e.g., one or more PUCCH-ResourceSet IEs)). In yet another example, the at least first configuration parameter can include at least one PUCCH format configuration (e.g., PHCCH-FormatConfig IE(s)), at least one PUCCH spatial relation configuration (e.g., PUCCH-SpatialRelationInfo IE(s)), a PUCCH power control configuration (e.g., PUCCH-PowerControl IE), and/or at least one downlink data to uplink acknowledge timing configuration (e.g., dl-DataToUL-ACK field, dl-DataToUL-ACK-DCI-1-2 field, dl-DataToUL-ACK-r16 field, and/or dl-DataToUL-ACK-DCI-1-2-r17 field). In some implementations, the at least one first uplink configuration parameter for the physical layer and the at least one second uplink configuration parameter for the physical layer can include the same configuration parameter(s) (value(s)). In other implementations, the at least one first uplink configuration parameter for the physical layer and the at least one second uplink configuration parameter for the physical layer can include different configuration parameter(s) (value(s)).

In other implementations, the RAN node can transmit at least one second uplink configuration parameter for the physical layer to the UE, e.g., in the at least one second message. When the UE receives a PDSCH transmission including a PDU associated with the MRB, the UE can transmit a HARQ feedback to the RAN node in accordance with the at least one second configuration parameter. For example, the at least one second configuration parameter can include a PUCCH configuration (e.g., PUCCH-Config IE). In another example, the at least one second configuration parameter can include at least one PUCCH resource configuration, which can include or configure one or more PUCCH resources (e.g., PUCCH-Resource IE(s)) and/or one or more PUCCH resource sets (e.g., one or more PUCCH-ResourceSet IEs)). In yet another example, the at least second configuration parameter can include at least one PUCCH format configuration (e.g., PHCCH-FormatConfig IE(s)), at least one PUCCH spatial relation configuration (e.g., PUCCH-SpatialRelationInfo IE(s)), a PUCCH power control configuration (e.g., PUCCH-PowerControl IE), and/or at least one downlink data to uplink acknowledgement timing configuration (e.g., dl-DataToUL-ACK field, dl-DataToUL-ACK-DCI-1-2 field, dl-DataToUL-ACK-r16 field, and/or dl-DataToUL-ACK-DCI-1-2-r17 field).

FIG. 6B is a flow diagram of an example method 600B, which is similar to the method 600A of FIG. 6A. At block 602, the DU (e.g., DU 174) determines to configure resources for an RB (e.g., events 506, 514, 593). At block 603, the DU includes a logical channel ID for the RB in a DU-to-CU message (e.g., events 508, 516, 593). At block 604, the DU determines whether the RB is an MRB. If the RB is not a MRB (e.g., if the RB is a unicast RB such as an SRB or a DRB), the flow proceeds to block 608. At block 608, the DU includes at least one configuration parameter for the RB in the DU-to-CU message. If the RB is an MRB, the flow instead proceeds to block 612. At block 612, the DU refrains from including the at least one configuration parameter for the RB in the DU-to-CU message (e.g., events 508, 516, 593). At block 614, the DU transmits the DU-to-CU message to a CU (e.g., events 508, 516, 593).

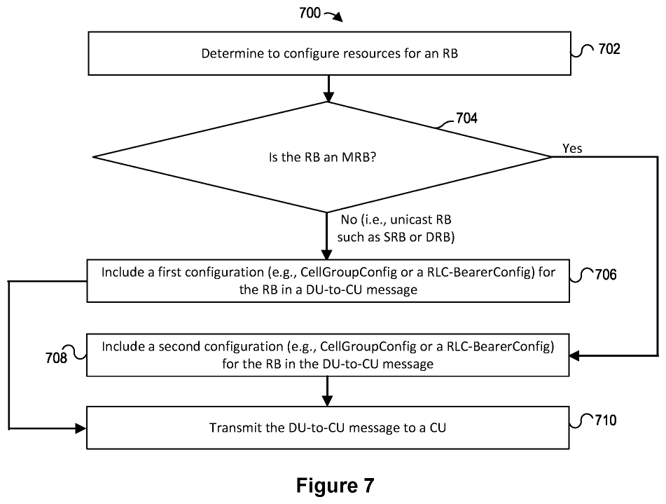

Referring next to FIG. 7, a DU such as the DU 174 can implement/perform a method 700 to determine to configure a first configuration or a second configuration for an RB. At block 702, the DU determines to configure resources for an RB (e.g., events 506, 514, 593). At block 704, the DU determines whether the RB is an MRB. If the RB is not an MRB (i.e., if the RB is a unicast RB such as an SRB or a DRB), the flow proceeds to block 706. At block 706, the DU includes a first configuration (e.g., a first CellGroupConfig IE or a first RLC-BearerConfig IE) for the RB in a DU-to-CU message. If the RB is an MRB, the flow instead proceeds to block 708. At block 708, the DU includes a second configuration (e.g., a second CellGroupConfig IE or a s second RLC-BearerConfig IE) for the RB in the DU-to-CU message (e.g., events 508, 516, 593). At block 710, the DU transmits the DU-to-CU message to a CU (e.g., events 508, 516, 593).

In some implementations, the first and second configurations include different configuration parameters and/or different values of configuration parameters. In some implementations, the first and second configurations include configuration parameters as described for FIGS. 5 and/or 6A.

In some implementations, the DU receives a CU-to-DU message from the CU as described for FIGS. 5 and/or 6A (e.g., events 506, 514, 593), and the DU determines to configure resources for the RB in response to the CU-to-DU message. In such implementations, the DU sends the DU-to-CU message in response to the CU-to-DU message.

In some implementations, if the RB is an MRB, the DU includes an RLC parameter (e.g., um-Uni-Directional-DL field) in the second configuration to indicate the RB is a DL-only RB (i.e., uni-directional DL RB). In some implementations, if the RB is a unicast RB, the DU includes an RLC parameter (e.g., am filed or um-Bi-Directional field) in the first configuration to indicate the RB is a bi-directional RB.

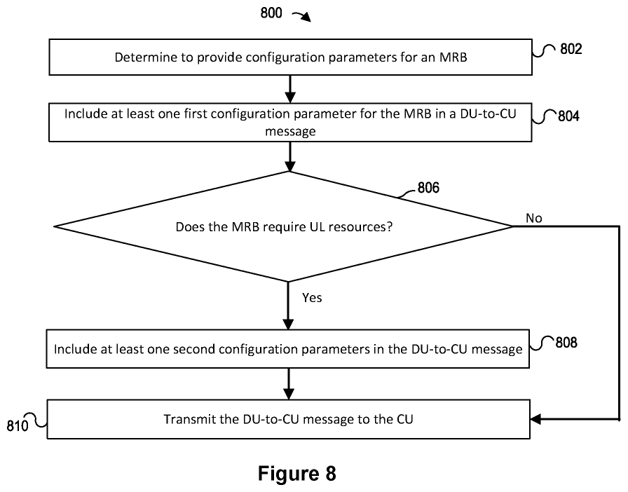

Now referring to FIG. 8, a DU such as the DU 174 can implement/perform an example method 800 to determine whether to configure at least one configuration parameter for an MRB.

More specifically, at block 802, the DU determines to provide configuration parameters for an MRB (e.g., events 506, 514, 593). At block 804, the DU includes at least one first configuration parameter for the MRB in a DU-to-CU message (e.g., events 508, 516, 593). At block 806, the DU determines whether the MRB requires UL resources. If the MRB requires UL resources, the flow proceeds to block 808. At block 808, the DU includes at least one second configuration parameter in the DU-to-CU message (e.g., events 508, 516, 593). If the MRB does not require UL resources, the flow instead proceeds to block 810. At block 810, the DU transmits the DU-to-CU message to the CU (e.g., events 508, 516, 593), i.e., without including the second configuration parameter(s) in the DU-to-CU message.

In some implementations, the DU determines whether the MRB requires UL resources at block 806 in accordance with QoS parameter(s) associated with the MRB. In some implementations, the DU receives at least one CU-to-DU message including the QoS parameter(s) from the CU. In other implementations, the DU is preconfigured with the QoS parameter(s) for the MRB.

In one implementation, if the QoS parameter(s) include particular QoS parameter(s) (e.g., first QoS parameter(s)), the DU determines at block 806 that the MRB requires UL resources. Otherwise (e.g., if the QoS parameter(s) does not include particular QoS parameter(s)), the DU determines at block 806 that the MRB does not require UL resources. For example, the QoS parameter(s) may include a QoS flow ID. If the QoS flow ID is a particular QoS flow ID (e.g., a first QoS flow ID), the DU determines at block 806 that the MRB requires UL resources. Otherwise (e.g., if the QoS flow ID (e.g., a second QoS flow ID) is not the particular QoS flow ID), the DU determines at block 806 that the MRB does not require UL resources. In another example, the QoS parameter(s) include QoS flow level QoS parameters. If the QoS flow level QoS parameters include particular QoS flow level QoS parameters (e.g., first QoS flow level QoS parameters), the DU determines at block 806 that the MRB requires UL resources. Otherwise (e.g., if the QoS flow level QoS parameters does not include the particular QoS flow level QoS parameters), the DU determines at block 806 that the MRB does not require UL resources. In another implementation, if the QoS parameter(s) include a QoS parameter for uplink, the DU determines at block 806 that the MRB requires UL resources. Otherwise (e.g., if the QoS parameter(s) does not include a QoS parameter for uplink), the DU determines at block 806 that the MRB does not require UL resources. For example, if the QoS parameter(s) includes a UE aggregate maximum bit rate for uplink, the DU may determine at block 806 that the MRB requires UL resources. Otherwise (e.g., if QoS parameter(s) does not include a UE aggregate maximum bit rate for uplink), the DU determines at block 806 that the MRB does not require UL resources. In yet another example, the QoS parameter(s) include a QoS identifier (e.g., 5G QoS identifier). If the QoS identifier is a particular QoS identifier (e.g., a first QoS identifier), the DU determines at block 806 that the MRB requires UL resources. Otherwise (e.g., if the QoS identifier (e.g., a second QoS identifier) is not the particular QoS identifier), the DU determines at block 806 that the MRB does not require UL resources.

In some implementations, the DU receives from the CU a CU-to-DU message for the MRB. If the CU-to-DU message includes an indication indicating UL resources are required, the DU determines at block 806 that the MRB requires UL resources. Otherwise (e.g., if the CU-to-DU message does not include an indication indicating UL resources are required for the MRB or includes an indication indicating DL-only resources required for the MRB), the DU determines at block 806 that the MRB does not require UL resources.

In some implementations, the at least one second configuration parameter is/are similar to the at least one configuration parameter described above for FIGS. 5 and 6A.

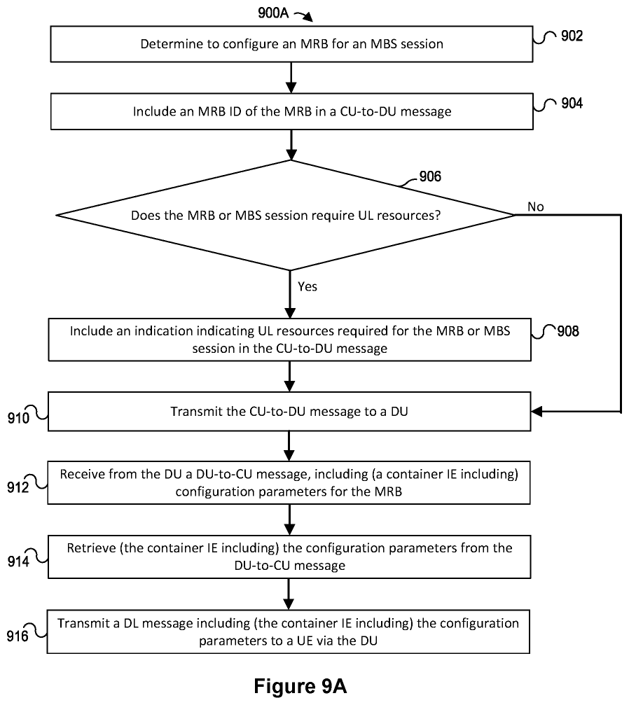

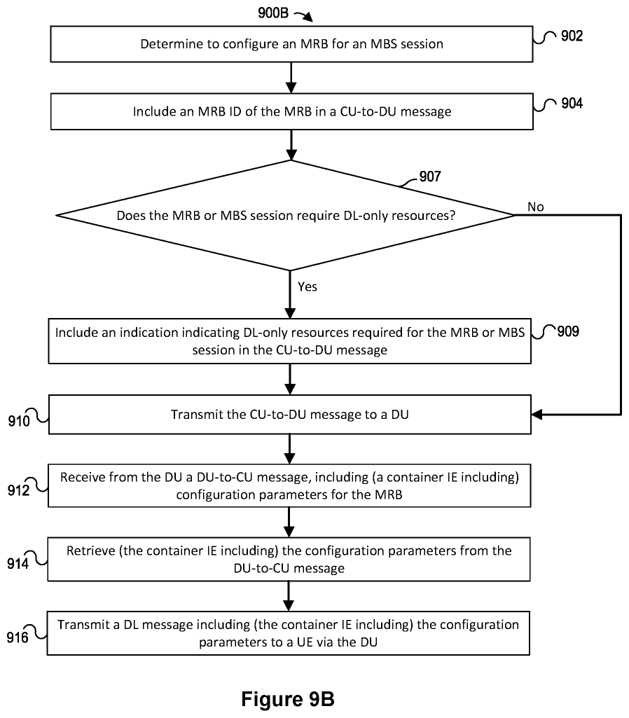

Referring next to FIG. 9A, a CU such as the CU 172 can implement/perform an example method 900A to indicate, or refrain from indicating, to a DU that uplink resources are required for an MRB or MBS session.

At block 902, the CU determines to configure an MRB for an MBS session (e.g., events 504, 591). At block 904, the CU includes an MRB ID of the MRB in a CU-to-DU message (e.g., events 506, 514, 593). At block 906, the CU determines whether the MRB or MBS session requires or does not require UL resources. If the MRB or MBS session requires UL resources, the flow proceeds to block 908. At block 908, the CU includes an indication indicating that UL resources are required for the MRB or MBS session in the CU-to-DU message (e.g., events 506, 514, 593). If the MRB or MBS session does not require UL resources, the flow instead proceeds to block 910. In this case, the CU refrains from including the indication in the CU-to-DU message. The flow proceeds to block 910 from block 906 (for the “no” branch) as well as from block 908. At block 910, the CU transmits the CU-to-DU message to a DU (e.g., events 506, 514, 593). At block 912, in response to the CU-to-DU message, the CU receives from the DU a DU-to-CU message, including (e.g., in a container IE) configuration parameters for the MRB (e.g., events 508, 516, 593). At block 914, the CU retrieves the configuration parameters (e.g., retrieves the container IE including the configuration parameters) from the DU-to-CU message (e.g., events 508, 516, 593). At block 916, the CU transmits a DL message including (e.g., in the container IE) the configuration parameters to a UE via the DU (e.g., events 518, 520, 593).

In some implementations, the CU receives from a CN (e.g., AMF) a CN-to-BS message including an MBS session ID of the MBS session from the CU, and the CU determines to configure the MRB for the MBS session in response to the CN-to-BS message. The CU can send a BS-to-CN message to the CN in response to the CN-to-BS message.

In some implementations, the CN-to-BS message and the BS-to-CN message can be next generation application protocol (NGAP) messages. In other implementations, the CN-to-BS message and the BS-to-CN message can be a PDU Session Resource Setup Request message and a PDU Session Resource Setup Response message, respectively. In other implementations, the CN-to-BS message and the BS-to-CN message can be a PDU Session Resource Modify Request message and a PDU Session Resource Modify Response message, respectively. In yet other implementations, the CN-to-BS message and the BS-to-CN message can be an MBS Session Resource Setup Request message and a MBS Session Resource Setup Response message, respectively. In yet other implementations, the CN-to-BS message and the BS-to-CN message can be an MBS Session Resource Modify Request message and an MBS Session Resource Modify Response message, respectively.

The CU can indicate the RB is a unicast RB (e.g., DRB or SRB) or an MRB in the CU-to-DU message. In some implementations, the CU can include an RB ID of the RB in the CU-to-DU message. In cases where the RB is an MRB, the RB ID can be an MRB ID. In cases where the RB is an SRB, the RB ID can be an SRB ID. In cases where the RB is a DRB, the RB ID is a DRB ID. In response to the CU-to-DU message, the DU determines to configure resources for the RB. Depending on whether the RB is an MRB or a unicast RB (e.g., DRB or SRB), the DU obtains different configuration parameters (e.g., logical channel ID and/or at least one configuration parameter) and includes the different configuration parameters in the DU-to-CU message as described above. The DU then transmits the DU-to-CU message to the CU in response to the CU-to-DU message. In some implementations, the DU can determine the RB is an MRB, an SRB or a DRB in accordance with the MRB indication, SRB indication, or DRB indication, respectively, for the RB. In other implementations, the DU can determine the RB is an MRB, an SRB, or a DRB in accordance with the MRB ID, SRB ID, or DRB ID, respectively.

In some implementations, the CU-to-DU message and the DU-to-CU message can be F1AP messages. In some implementations, the CU-to-DU message and the DU-to-CU message can be a UE Context Setup Request message and a UE Context Setup Response message, respectively. In other implementations, the CU-to-DU message and the DU-to-CU message can be a UE Context Modification Request message and a UE Context Modification Response message, respectively. In yet other implementations, the CU-to-DU message and the DU-to-CU message can be an MBS Context Setup Request message and an MBS Context Setup Response message, respectively. In yet other implementations, the CU-to-DU message and the DU-to-CU message can be an MBS Context Modification Request message and an MBS Context Modification Response message, respectively.

In some implementations, the container IE can be a cell group configuration (CellGroupConfig IE). In some implementations, the CU determines whether the MRB or MBS session requires UL resources in accordance with QoS parameter(s) associated with the MRB or MBS session. In some implementations, the CN-to-BS message (i.e., the first CN-to-BS message) includes the QoS parameter(s). In other implementations, the CU receives a second CN-to-BS message including the QoS parameter(s) from the CN. In yet other implementations, the CU is preconfigured with the QoS parameter(s) for the MRB or MBS session. In one implementation, if the QoS parameter(s) include particular QoS parameter(s) (e.g., first QoS parameter(s)), the CU determines at block 906 that the MRB or MBS session requires UL resources. Otherwise (e.g., if the QoS parameter(s) does not include particular QoS parameter(s)), the CU determines at block 906 that the MRB or MBS session does not require UL resources. For example, the QoS parameter(s) include a QoS flow ID. If the QoS flow ID is a particular QoS flow ID (e.g., a first QoS flow ID), the CU determines at block 906 that the MRB or MBS session requires UL resources. Otherwise (e.g., if the QoS flow ID (e.g., a second QoS flow ID) is not the particular QoS flow ID), the CU determines at block 906 that the MRB or MBS session does not require UL resources. In another example, the QoS parameter(s) include QoS flow level QoS parameters. If the QoS flow level QoS parameters include particular QoS flow level QoS parameters (e.g., first QoS flow level QoS parameters), the CU determines at block 906 that the MRB requires UL resources. Otherwise (e.g., if the QoS flow level QoS parameters does not include the particular QoS flow level QoS parameters), the CU determines at block 906 that the MRB does not require UL resources. In another implementation, if the QoS parameter(s) include a QoS parameter for uplink, the CU determines at block 906 that the MRB requires UL resources. Otherwise (e.g., if the QoS parameter(s) does not include a QoS parameter for uplink), the CU determines at block 906 that the MRB does not require UL resources. For example, if the QoS parameter(s) includes a UE aggregate maximum bit rate for uplink, the CU determines at block 906 that the MRB requires UL resources. Otherwise (e.g., if QoS parameter(s) does not include a UE aggregate maximum bit rate for uplink), the CU determines at block 906 that the MRB does not require UL resources. In yet another example, the QoS parameter(s) include a QoS identifier (e.g., 5G QoS identifier). If the QoS identifier is a particular QoS identifier (e.g., a first QoS identifier), the CU determines at block 906 that the MRB requires UL resources. Otherwise (e.g., if the QoS identifier (e.g., a second QoS identifier) is not the particular QoS identifier), the CU determines at block 906 that the MRB does not require UL resources.

In some implementations, if the first or second CN-to-BS message includes an indication indicating UL resources required, the CU determines at block 906 the MRB or MBS session requires UL resources. Otherwise (e.g., if the first or second CN-to-BS message does not include an indication indicating UL resources required for the MRB or includes an indication indicating DL-only resources required for the MRB), the CU determines at block 906 the MRB or MBS session does not require UL resources.

In some implementations, the indication at block 908 is a new IE. In other implementations, the indication at block 908 is the QoS parameter(s) described above.

In response to the indication indicating UL resources required for the MRB or MBS session, the DU in some implementations generates at least one configuration parameter and includes the at least one configuration parameter in the container IE or the DU-to-CU message. In such implementations, the DU can include at least one first uplink configuration parameter for a PHY in the container UE or the DU-to-CU message. Examples and implementations of the at least one configuration parameter and the at least one first uplink configuration parameter for a PHY are as described above for FIG. 6A.

If the MRB or MBS session does not require UL resources, the CU in some implementations can include an indication indicating UL resources are not required for the MRB or MBS session. If the MRB or MBS session does not require UL resources, the CU in other implementations can include an indication indicating DL-only resources are required for the MRB or MBS session.

In cases where the CU-to-DU message excludes the indication indicating that UL resources are required, or includes an indication indicating that UL resources are not required or an indication that DL-only resources are required, the DU does not include the at least one configuration parameter in the container IE or the DU-to-CU message. In such cases, the DU may include at least one first uplink configuration parameter for a PHY in the container UE or the DU-to-CU message, in some implementations. Alternatively, the DU may not include the at least one first uplink configuration parameter for a PHY in the container UE or the DU-to-CU message.

FIG. 9B illustrates an example method 900B that is similar to method 900A, except that method 900B includes blocks 907 and 909 instead of blocks 906 and 908.

At block 907, the CU determines whether the MRB or MBS session requires or does not require DL-only resources. If the MRB or MBS session requires DL-only resources, the flow proceeds to block 909. At block 909, the CU includes an indication indicating DL-only resources are required for the MRB or MBS session in the CU-to-DU message (e.g., events 506, 514, 593). If the MRB or MBS session requires UL resources, the flow instead proceeds to block 910. The flow proceeds to block 910 from block 907 (the “no” branch) as well as from block 909.

Examples and implementations described above for FIG. 9A can also apply to FIG. 9B.

In cases where the CU-to-DU message excludes the indication indicating that DL-only resources are required, the DU in some implementations generates the at least one configuration parameter and includes the at least one configuration parameter in the container IE or the DU-to-CU message. In such implementations, the DU can further include the at least one first uplink configuration parameter for a PHY in the container UE or the DU-to-CU message.

In response to the indication indicating that DL-only resources are required, the DU does not include the at least one configuration parameter in the container IE or the DU-to-CU message. In such cases, the DU may include at least one first uplink configuration parameter for a PHY in the container UE or the DU-to-CU message, in some implementations. Alternatively, the DU does not include the at least one first uplink configuration parameter for a PHY in the container UE or the DU-to-CU message.

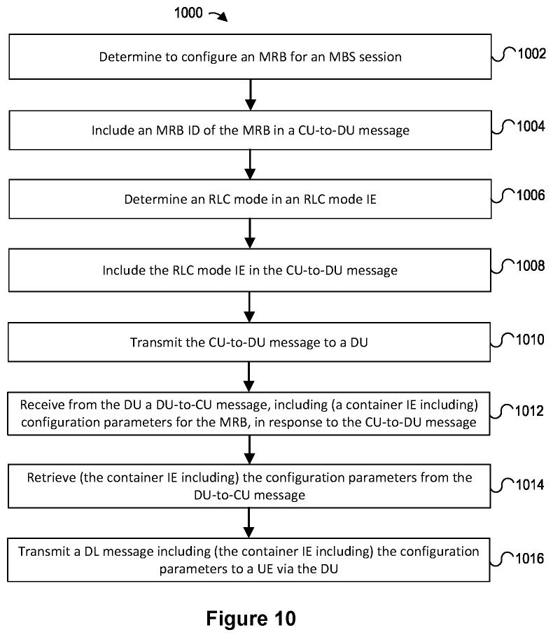

Referring next to FIG. 10, a CU such as the CU 172 can implement/perform an example method 1000 to determine an RLC mode for an MRB.

At block 1002, the CU determines to configure an MRB for an MBS session (e.g., events 504, 591). At block 1004, the CU includes an MRB ID of the MRB in a CU-to-DU message (e.g., events 506, 514, 593). At block 1006, the CU determines an RLC mode in an RLC mode IE. At block 1008, the CU includes the RLC mode IE in the CU-to-DU message (e.g., events 506, 514, 593). At block 1010, the CU transmits the CU-to-DU message to a DU (e.g., events 506, 514, 593). At block 1012, in response to the CU-to-DU message, the CU receives from the DU a DU-to-CU message, including (e.g., in a container IE) configuration parameters for the MRB (e.g., events 508, 516, 593). At block 1014, the CU retrieves the configuration parameters (e.g., retrieves the container IE including the configuration parameters) from the DU-to-CU message. At block 1016, the CU transmits a DL message (including the container IE) including the configuration parameters to a UE via the DU (e.g., events 518, 520, 593).

In some implementations, the CU determines the RLC mode based on the QoS parameter(s) for the MBS session as described above. For example, the CU may determine the RLC mode to be an RLC acknowledged mode (AM) if the QoS parameter(s) indicate a certain level of reliability is required. Otherwise, the CU determines the RLC mode to be an RLC unacknowledged mode (UM). In another example, the CU determines the RLC mode to be an RLC UM if the QoS parameter(s) indicate a certain level of latency is required. Otherwise, the CU determines the RLC mode to be an RLC AM. More generally, the CU determines the RLC mode to be an RLC AM if the QoS parameter(s) include particular QoS parameter(s) (e.g., first QoS parameter(s)). Otherwise (i.e., if the QoS parameter(s) include second QoS parameter(s)), the CU determines the RLC mode to be an RLC UM.

In some implementations, the DU generates an RLC bearer configuration in accordance with the RLC mode IE. If the RLC mode IE indicates RLC AM, the RLC bearer configuration includes an indication indicating RLC AM and/or RLC AM parameters. If the RLC mode IE indicates RLC UM, the RLC bearer configuration includes an indication indicating RLC AM and/or RLC UM parameters. The DU includes the RLC bearer configuration in the configuration parameters. Thus, the DU transmits MBS data of the MBS session using the RLC mode configured in the RLC bearer configuration via multicast or unicast. The UE receives the MBS data using the RLC mode.

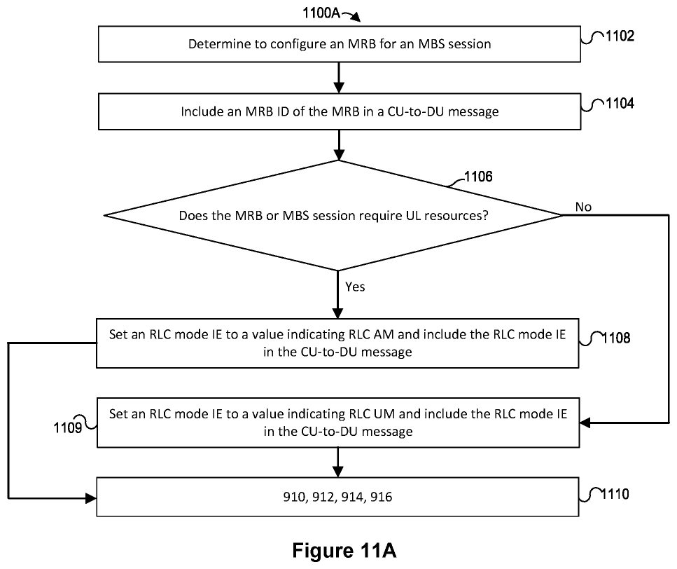

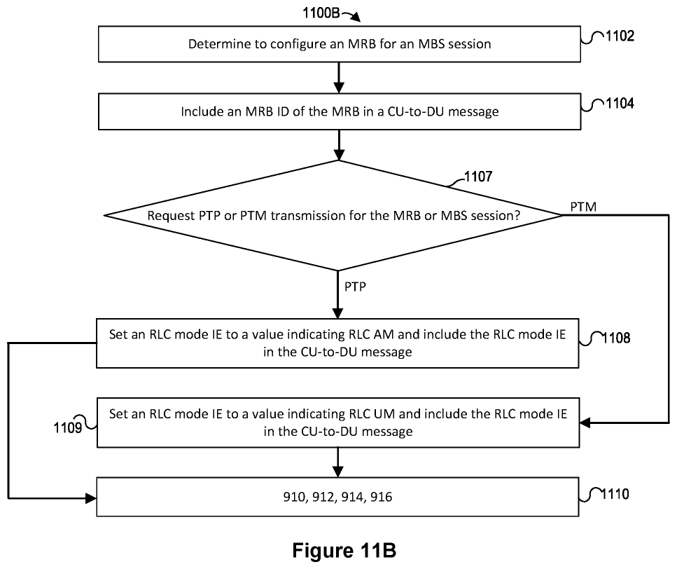

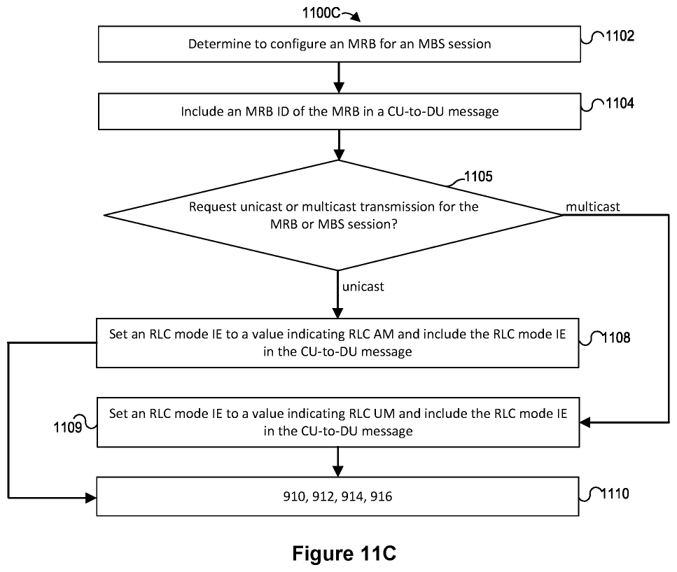

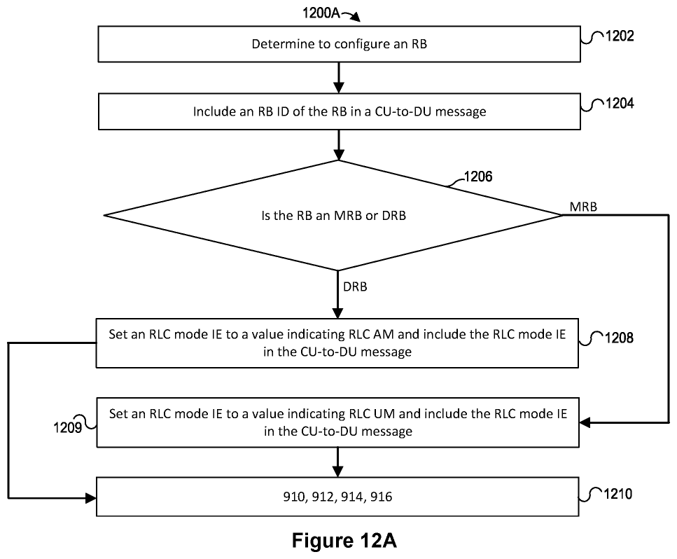

Now referring to FIG. 11A, a CU such as the CU 172 can implement/perform an example method 1100A to determine an RLC mode for an MRB.

The method 1100A begins at block 1102, where the CU determines to configure an MRB for an MBS session (e.g., events 504, 591). At block 1104, the CU includes an MRB ID of the MRB in a CU-to-DU message (e.g., events 506, 514, 593). At block 1106, the CU determines whether the MRB or MBS session requires or does not require UL resources. If the MRB or MBS session requires UL resources, the flow proceeds to block 1108. At block 1108, the CU sets an RLC mode IE to a value indicating RLC AM and includes the RLC mode IE in the CU-to-DU message (e.g., events 506, 514, 593). If the MRB or MBS session does not require UL resources, the instead flow proceeds to block 1109. At block 1109, the CU sets an RLC mode IE to a value indicating RLC UM and includes the RLC mode IE in the CU-to-DU message (e.g., events 506, 514, 593). The flow proceeds to block 1110 from block 1108 as well as from block 1109. At block 1110, the CU performs the actions described above for blocks 910, 912, 914, and 916. Examples and implementations described above for FIG. 10 can also apply to FIG. 11A.

FIG. 11B illustrates an example method 1100B that is similar to method 1100A, except that method 1100B includes block 1107 instead of block 1106. At block 1107, the CU determines whether to request PTP transmission, or instead PTM transmission, for the MRB or MBS session (e.g., events 504, 591). If the CU requests PTP transmission for the MRB or MBS session, the flow proceeds to block 1108. If the CU requests PTM transmission for the MRB or MBS session, the flow instead proceeds to block 1109.

FIG. 11C illustrates an example method 1100C that is similar to method 1100A, except that method 1100C includes block 1105 instead of block 1106. At block 1105, the CU determines whether to request unicast transmission, or instead request multicast transmission, for the MRB or MBS session (e.g., events 504, 591). If the CU requests PTP transmission for the MRB or MBS session, the flow proceeds to block 1108. If the CU requests PTM transmission for the MRB or MBS session, the flow instead proceeds to block 1109.

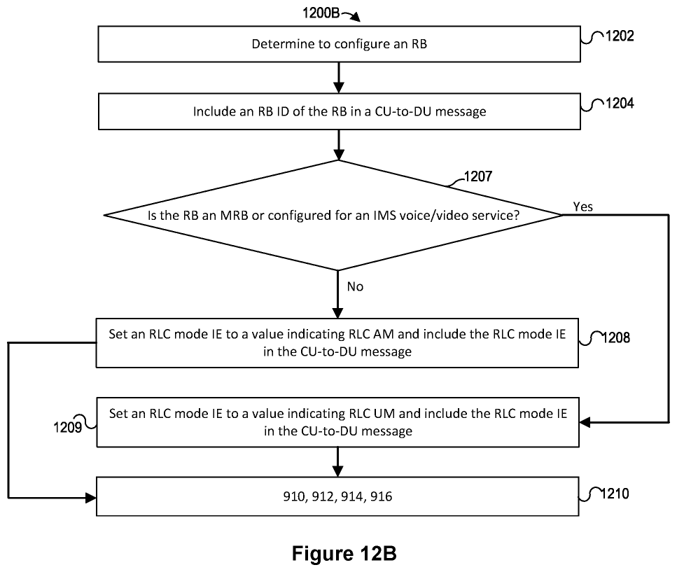

Now referring to FIG. 12A, a CU such as the CU 172 can implement an example method 1200A to determine an RLC mode for an MRB.

The method 1200A begins at block 1202, where the CU determines to configure an RB (e.g., events 504, 591). At block 1204, the CU includes an RB ID of the RB in a CU-to-DU message (e.g., events 506, 514, 593). At block 1206, the CU determines whether the RB is an MRB or a DRB. If the RB is a DRB, the flow proceeds to block 1208. At block 1208, the CU sets an RLC mode IE to a value indicating RLC AM and includes the RLC mode IE in the CU-to-DU message (e.g., events 506, 514, 593). If the RB is an MRB, the flow proceeds to block 1209. At block 1209, the CU sets an RLC mode IE to a value indicating RLC UM and includes the RLC mode IE in the CU-to-DU message (e.g., events 506, 514, 593). The flow proceeds to block 1210 from block 1208 as well as from block 1209. At block 1210, the CU performs actions as described above for blocks 910, 912, 914, and 916.

FIG. 12B illustrates an example method 1200B that is similar to method 1200A, except that method 1200B includes block 1207 instead of block 1206. At block 1207, the CU determines whether the RB is or is not either an MRB or configured for an IMS voice or video service (e.g., events 504, 591). If the RB is an MRB or configured for an IMS voice or video service, the flow proceeds to block 1208. Otherwise, the flow proceeds instead to block 1209. The IMS voice service can be an IMS voice call or an IMS emergency call.

In some implementations, if the RB is an MRB, the CU can include a uni-directional indication in the CU-to-DU message to indicate that the RB is a DL-only RB (i.e., uni-directional DL RB). In response to the uni-directional indication, the DU can include an RLC parameter (e.g., um-Uni-Directional-DL field) in the configuration parameters in the DU-to-CU message for the RB. If the RB is configured for an IMS voice or video service, the CU does not include the uni-directional indication.

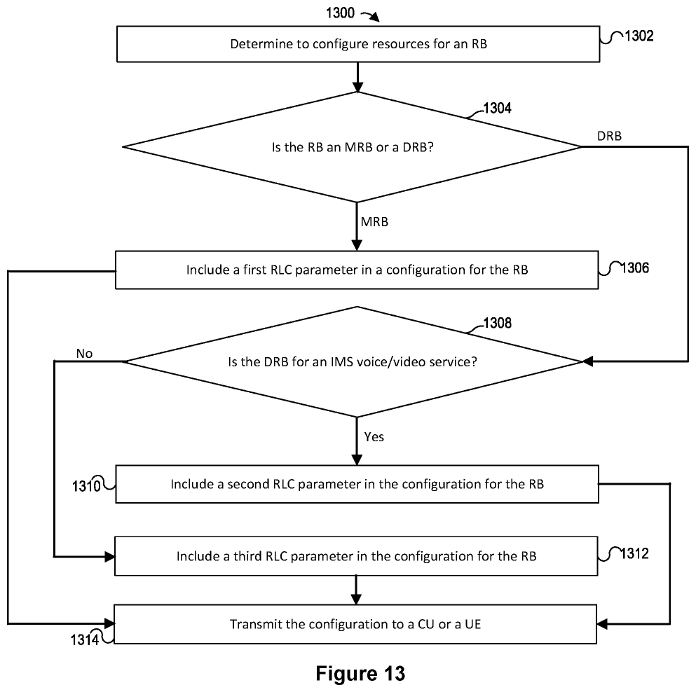

Now referring to FIG. 13, a RAN node such as the DU 174 or base station 104 can implement an example method 1300 to determine an RLC parameter for an RB (i.e., an MRB or a DRB).

At block 1302, the RAN node determines to configure resources for an MRB (e.g., events 506, 514, 593). At block 1304, the RAN node determines whether the RB is an MRB or a DRB. If the RB is an MRB, the flow proceeds to block 1306. At block 1306, the RAN node includes a first RLC parameter in a configuration (e.g., an RLC configuration such as an RLC-BearerConfig IE) for the RB. If the RB is a DRB, the flow instead proceeds to block 1308. At block 1308, the RAN node determines whether the DRB is or is not for an IMS voice or video service. If the DRB is for an IMS voice or video service, the flow proceeds to block 1310. At block 1310, the RAN node includes a second RLC parameter in the configuration for the RB. If the DRB is not for an IMS voice or video service, the flow instead proceeds to block 1312. At block 1312, the RAN node includes a third RLC parameter in the configuration for the RB. The flow proceeds to block 1314 from each of blocks 1306, 1310, and 1312. At block 1314, the RAN node transmits the configuration to a CU or a UE (e.g., events 508, 516, 520, 593). In cases where the RAN node is a DU (e.g., the DU 174), the DU in some implementations can send a DU-to-CU message including the configuration to the CU. In cases where the RAN node is a base station (e.g., base station 104), the base station in some implementations can send a DL message (e.g., RRC reconfiguration message) including the configuration to the UE.

In some implementations, the first RLC parameter, the second RLC parameter, and the third RLC parameter can be an um-Uni-Directional-DL field, an um-Bi-Directional field, and an am field, respectively. In some implementations, the DU can indicate a first RLC sequence number size, a second RLC sequence number size, and a third RLC sequence number size in the first RLC parameter, second RLC parameter, and third RLC parameter, respectively. At least two (e.g., all) of the first, second, and third RLC sequence number sizes can be the same or different.

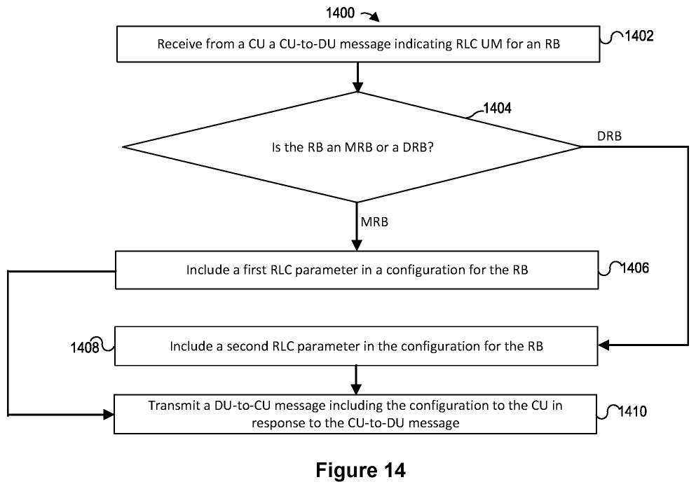

Now referring to FIG. 14, a DU such as the DU 174 can implement/perform an example method 1300 to determine an RLC parameter for an RB (i.e., an MRB or a DRB).

At block 1402, the DU receives from a CU a CU-to-DU message indicating an RLC UM for an RB (e.g., events 506, 514, 593). At block 1404, the DU determines whether the RB is an MRB or a DRB. If the RB is an MRB, the flow proceeds to block 1406. At block 1406, the DU includes a first RLC parameter in a configuration (e.g., an RLC configuration such as an RLC-BearerConfig IE) for the RB. If the RB is an DRB, the flow instead proceeds to block 1408. At block 1408, the DU includes a second RLC parameter in the configuration for the RB. The flow proceeds to block 1410 from block 1406 as well as from block 1408. At block 1410, the DU transmits the DU-to-CU message including the configuration to the CU (e.g., events 508, 516, 593).

In some implementations, the first RLC parameter and the second RLC parameter can be an um-Uni-Directional-DL field and an um-Bi-Directional field, respectively. In some implementations, the DU can indicate a first RLC sequence number size and a second RLC sequence number size in the first RLC parameter and the second RLC parameter, respectively. The first and second sequence number sizes can be the same or different.

The following additional considerations apply to the foregoing discussion.

In some implementations, “message” is used and can be replaced by “information element (IE)”. In some implementations, “IE” is used and can be replaced by “field”. In some implementations, “configuration” can be replaced by “configurations” or the configuration parameters. In some implementations, “MBS” can be replaced by “multicast” or “broadcast”.

A user device in which the techniques of this disclosure can be implemented (e.g., the UE 102A, 102B, or 103) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional alternative structural and functional designs for communicating MBS information through the disclosed principles herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A method, performed by a distributed unit (DU) of a distributed base station, for configuring a radio bearer, the method comprising:
receiving, from a central unit (CU) of the distributed base station, a request to configure radio resources for a radio bearer;
based on one or more factors associated with the radio bearer, either including or refraining from including in a response one or more configuration parameters for the radio bearer; and
transmitting the response to the CU.

2. The method of claim 1, wherein the one or more configuration parameters for the radio bearer include one or more configuration parameters for an uplink for the radio bearer.

3. The method of claim 1, comprising:
refraining from including in the response the one or more configuration parameters when a first factor of the one or more factors indicates that the radio bearer is a multicast and/or broadcast services (MBS) radio bearer (MRB); and
including in the response the one or more configuration parameters when the first factor indicates that the radio bearer is not an MRB.

4. The method of claim 3, further comprising including in the response a logical channel identifier for the radio bearer.

5. The method of claim 4, wherein including in the response the logical channel identifier includes:
including a first logical channel identifier in the response when the first factor indicates the radio bearer is an MRB; and
including a second logical channel identifier, different from the first logical channel identifier, in the response when the first factor indicates the radio bearer is not an MRB.

6. The method of claim 4, wherein including in the response the logical channel identifier includes:
including a same logical channel identifier in the response irrespective of whether the radio bearer is an MRB.

7. The method of claim 1, comprising:
including in the response the one or more configuration parameters when a first factor of the one or more factors indicates that the radio bearer is a multicast and/or broadcast services (MBS) radio bearer (MRB); and
including in the response one or more other configuration parameters, different from the one or more configuration parameters, when the first factor indicates that the radio bearer is not an MRB.

8. The method of claim 7, wherein the one or more configuration parameters include a cell group configuration and/or a radio link control (RLC) bearer configuration.

9. The method of claim 1, comprising:
including the one or more configuration parameters in the response when a first factor of the one or more factors is an indication, in the request, that uplink resources are required.

10. The method of claim 9, comprising:
refraining from including the one or more configuration parameters in the response when the first factor is an indication, in the request, that uplink resources are not required.

11. The method of claim 10, comprising:
refraining from including the one or more configuration parameters in the response when the first factor is an indication, in the request, that downlink-only resources are required.

12. The method of claim 1, comprising:
including a first radio link control (RLC) parameter in the response when a first factor of the one or more factors indicates that the radio bearer is a multicast and/or broadcast services (MBS) radio bearer (MRB); and
including a second RLC parameter, different from the first RLC parameter, in the response when the first factor indicates that the radio bearer is not an MRB.

13. The method of claim 12, comprising:
including the second RLC parameter in the response when the first factor indicates that the radio bearer is a data radio bearer (DRB).

14. The method of claim 1, wherein the one or more configuration parameters include one or more of:
a logical channel configuration;
uplink configuration parameters for a medium access control (MAC) layer;
a logical channel group;
a subcarrier spacing list;
a scheduling request identifier;
a timer value;
a physical priority index;
a channel access priority; and
a bitrate multiplier.

15.-44. (canceled)

45. A distributed unit (DU) of a distributed base station, the DU comprising processing hardware and being configured to:
receive, from a central unit (CU) of the distributed base station, a request to configure radio resources for a radio bearer;
based on one or more factors associated with the radio bearer, either include or refrain from including in a response one or more configuration parameters for the radio bearer; and
transmit the response to the CU.

46. The DU of claim 45, wherein the one or more configuration parameters for the radio bearer include one or more configuration parameters for an uplink for the radio bearer.

47. The DU of claim 45, wherein the DU is configured to:
refrain from including in the response the one or more configuration parameters when a first factor of the one or more factors indicates that the radio bearer is a multicast and/or broadcast services (MBS) radio bearer (MRB); and
include in the response the one or more configuration parameters when the first factor indicates that the radio bearer is not an MRB.

48. The DU of claim 47, wherein the DU is configured to:
include in the response a logical channel identifier for the radio bearer.

49. The DU of claim 48, wherein including in the response the logical channel identifier includes:
including a first logical channel identifier in the response when the first factor indicates the radio bearer is an MRB; and
including a second logical channel identifier, different from the first logical channel identifier, in the response when the first factor indicates the radio bearer is not an MRB.

50. The DU of claim 48, wherein including in the response the logical channel identifier includes:
including a same logical channel identifier in the response irrespective of whether the radio bearer is an MRB.
